(19) United States
(12) Patent Application Publication
(10) Pub. No.: US 2025/0159674 A1
(43) Pub. Date: May 15, 2025

(54) METHODS, APPARATUS, AND SYSTEMS FOR SUPPORTING COORDINATED TRANSMISSIONS FOR COLLABORATIVE USER EQUIPMENT (UEs)

(71) Applicant: InterDigital Patent Holdings, Inc., Wilmington, DE (US)

(72) Inventors: Tejaswinee Lutchoomun, Montreal (CA); Jaya Rao, Montreal (CA); Senay Negusse, Montreal (CA); Ananth Kini, Conshohocken, PA (US); Ahmed Mostafa, Ottawa (CA); Ghyslain Pelletier, Montréal (CA); Benoit Pelletier, Roxboro (CA)

(21) Appl. No.: 18/837,069

(22) PCT Filed: Feb. 8, 2023
(86) PCT No.: PCT/US2023/012607

§ 371 Date: Aug. 8, 2024

Related U.S. Application Data
(60) Provisional application No. 63/309,150, filed on Feb. 11, 2022.
(60) Provisional application No. 63/335,019, filed on Apr. 26, 2022.
(60) Provisional application No. 63/394,854, filed on Aug. 3, 2022.
(60) Provisional application No. 63/410,757, filed on Sep. 28, 2022.

(51) Int. Cl. H04W 72/121; H04W 72/0446; H04W 72/21

(52) U.S. Cl. CPC H04W 72/121; H04W 72/0446; H04W 72/21

(57) ABSTRACT

Methods, apparatus, and systems are disclosed. In one method, a first WTRU of a WTRU group receives configuration information indicating WTRU IDs for one or more WTRUs in the WTRU group, one or more configured grants (CGs) associated with the one or more WTRUs, and a threshold value. The method may further include, on condition that the first WTRU determines that respective timing information associated with a respective one of the one or more WTRUs is above the threshold value, determining for the respective WTRU a respective preferred CG and indicating the respective preferred CG and WTRU ID of the respective WTRU to the network.

### CROSS-REFERENCE TO RELATED APPLICATIONS

This application claims the benefit of U.S. Patent Application No. 63/309,150 filed Feb. 11, 2022, U.S. Patent Application No. 63/335,019 filed Apr. 26, 2022, U.S. Patent Application No. 63/394,854 filed Aug. 3, 2022, and U.S. Patent Application No. 63/410,757 filed Sep. 28, 2022. The contents of these earlier filed applications are incorporated herein by reference in their entirety for all purposes.

### FIELD

Embodiments disclosed herein generally relate to wireless communications and, for example, to methods, apparatus, architectures and systems for supporting coordinated transmissions for collaborative UEs.

### BACKGROUND

Extended Reality (XR) may refer to different types of immersive experiences, such as Virtual Reality (VR), Augmented Reality (AR) and Mixed Reality (MR) and the realities interpolated among them. VR is a rendered version of a delivered visual and audio scene. The rendering may be designed to mimic the visual (e.g., stereoscopic 3D) and audio sensory stimuli of the real world as naturally as possible to an observer or user as they move within the limits defined by the application. AR may be when a user is provided with additional information or artificially generated items and/or content overlaid upon their current environment. MR may be an advanced form of AR where some virtual elements may be inserted into a physical scene, for example, with the intent to provide the illusion that these elements are part of the real scene. XR may allude to (e.g., be associated with) real and virtual (e.g., all real-and-virtual) combined environments and human-machine interactions generated by computer technology and wearables. XR applications may be supported by one or more devices, nodes and/or user equipment (UEs).

### SUMMARY

An embodiment may be directed to a method that can be implemented by a first WTRU (e.g., anchor UE) of a WTRU group. The method may include receiving configuration information indicating WTRU IDs for one or more WTRUs in the WTRU group, one or more configured grants (CGs) associated with the one or more WTRUs, and/or a threshold value. The method may further include determining that respective timing information associated with a respective one of the one or more WTRUs is above the threshold value, determining and/or selecting for the respective WTRU a respective CG(s) and indicating the selected respective CG(s) and WTRU ID of the respective WTRU to the network.

An embodiment may be directed to a WTRU including at least one processor and at least one transceiver. The transceiver may be configured to receive configuration information indicating WTRU IDs for one or more WTRUs in the WTRU group, one or more configured grants (CGs) associated with the one or more WTRUs, and/or a threshold value. On condition that it is determined that respective timing information associated with a respective one of the one or more WTRUs is above the threshold value, the processor may be configured to determine and/or select for the respective WTRU respective CG(s) and the transceiver may be configured to indicate the selected respective CG(s) and WTRU ID of the respective WTRU to the network.

### BRIEF DESCRIPTION OF THE DRAWINGS

A more detailed understanding may be had from the detailed description below, given by way of example in conjunction with drawings appended hereto. Figures in the description, are examples. As such, the Figures (FIGS.) and the detailed description are not to be considered limiting, and other equally effective examples are possible and likely. Furthermore, like reference numerals in the figures may indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A, according to an embodiment;

FIG. 1C is a system diagram illustrating an example radio access network (RAN) and an example core network (CN) that may be used within the communications system illustrated in FIG. 1A, according to an embodiment;

FIG. 1D is a system diagram illustrating a further example RAN and a further example CN that may be used within the communications system illustrated in FIG. 1A, according to an embodiment;

FIG. 2 is a diagram illustrating a set of UEs (e.g., UE A and UE B) that form at least a part of a collaborative UE group taking part in a collaborative action, according to an embodiment;

FIG. 3 is a diagram illustrating coordinated transmission in a collaborative UE group including an anchor UE and a collaborative UE, according to an embodiment;

FIG. 4A is a diagram illustrating coordinated transmission in a collaborative UE group including an anchor UE and a collaborative UE, according to an embodiment;

FIG. 4B is a flow diagram illustrating a method for coordinated transmission in a collaborative UE group, according to an embodiment; and

FIG. 5 is a flow diagram illustrating a method for coordinated transmission in a collaborative UE group, according to an embodiment.

### DETAILED DESCRIPTION

In the following detailed description, numerous specific details are set forth to provide a thorough understanding of certain embodiments and/or examples disclosed herein. However, it will be understood that such embodiments and examples may be practiced without some or all of the specific details set forth herein. In other instances, well-known methods, procedures, components and circuits might not be described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System(s) or Network(s) for Implementation of Example Embodiments

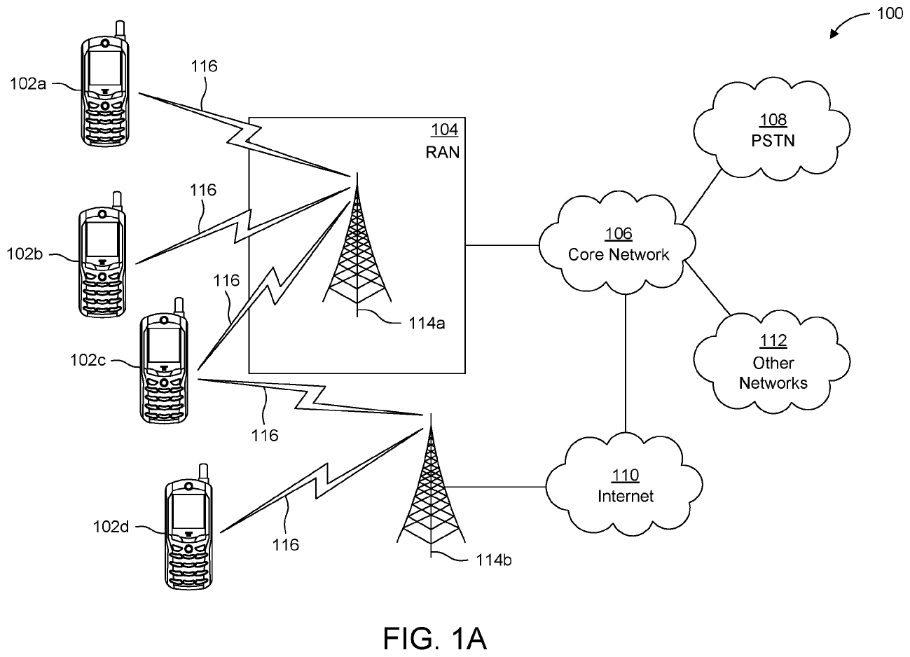

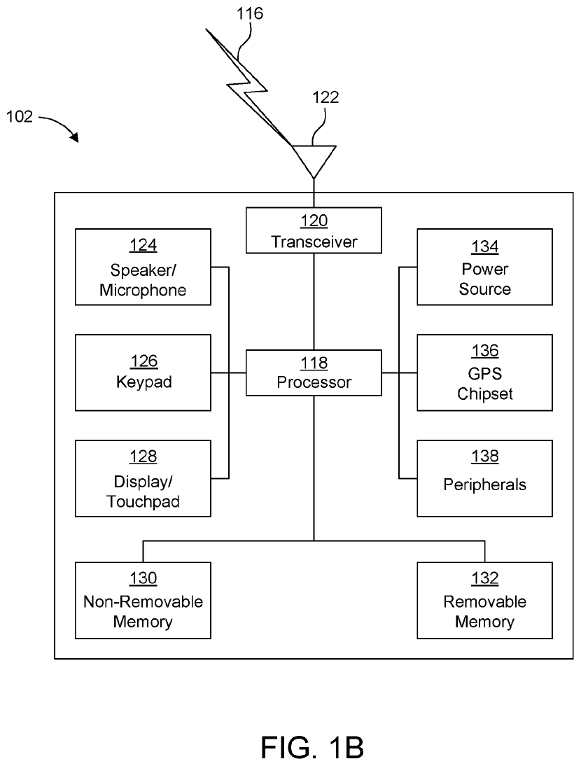

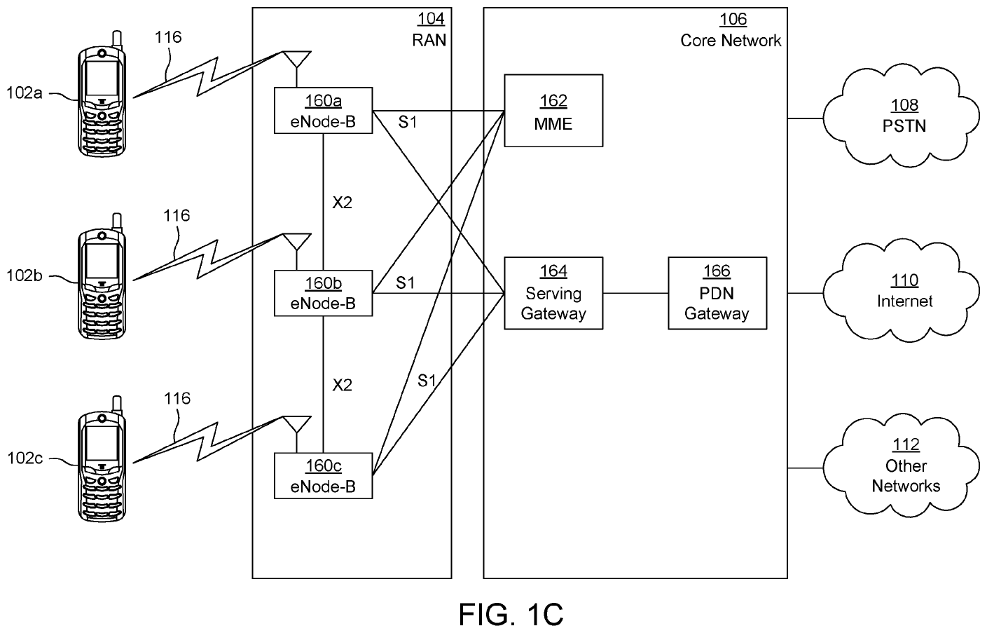

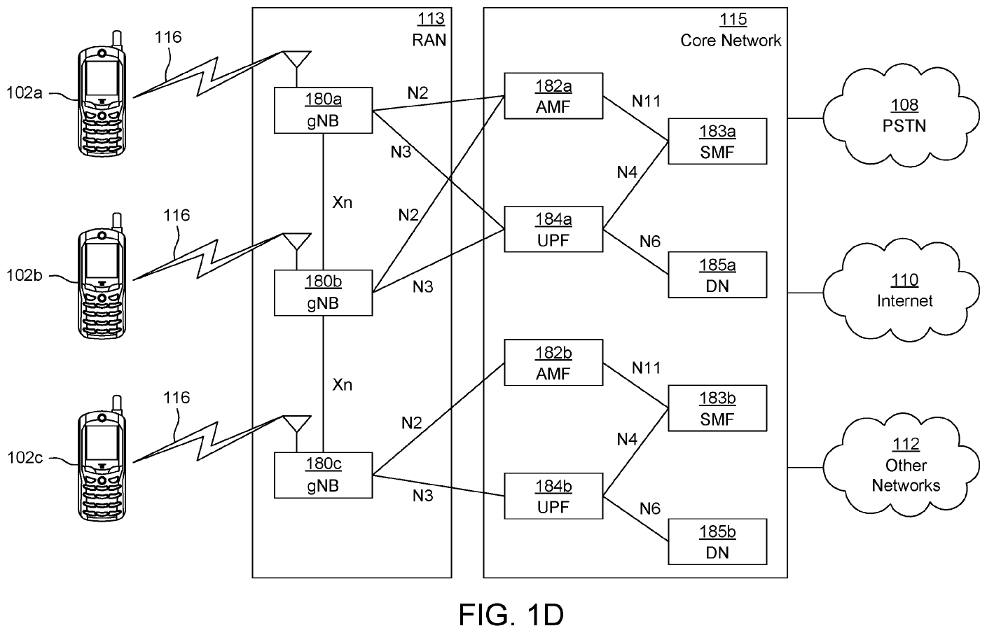

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, and/or any other WTRU referred to or mentioned herein, may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (end), a Home Node B (HNB), a Home eNode B (HeNB), a gNB, a NR Node B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The processor 118 of the WTRU 102 may operatively communicate with various peripherals 138 including, for example, any of: the one or more accelerometers, the one or more gyroscopes, the USB port, other communication interfaces/ports, the display and/or other visual/audio indicators to implement representative embodiments disclosed herein.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode Bs 160a, 160b, 160c, though it will be appreciated that the RAN 104 may include any number of eNode Bs while remaining consistent with an embodiment. The eNode Bs 160a, 160b, 160c may each include one or more transceivers for communicating with the WTRUs 102a, 102b, 102c over the air interface 116. In one embodiment, the eNode Bs 160a, 160b, 160c may implement MIMO technology. Thus, the eNode B 160a, for example, may use multiple antennas to transmit wireless signals to, and/or receive wireless signals from, the WTRU 102a.

Each of the eNode Bs 160a, 160b, 160c may be associated with a particular cell (not shown) and may be configured to handle radio resource management decisions, handover decisions, scheduling of users in the UL and/or DL, and the like. As shown in FIG. 1C, the eNode Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped onto the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode Bs 160a, 160b, 160c. For example, WTRUs 102a, 102b, 102c may implement DC principles to communicate with one or more gNBs 180a, 180b, 180c and one or more eNode Bs 160a, 160b, 160c substantially simultaneously. In the non-standalone configuration, eNode Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface. Any of the terms “gNB”, “network entity” “base station” and/or “access point” may be used interchangeably.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements is depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Protocol Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency communication (URLLC) access, services relying on enhanced mobile (e.g., massive mobile) broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain representative embodiments, methods, apparatus and/or systems may be implemented to support coordinated transmissions/receptions for one or more user equipment (UEs) in a collaborative UE group.

In certain representative embodiments, one or more identifiers (IDs) may be implemented to associate the UEs in a collaborative UE group.

In certain representative embodiments, the UE may send information and/or an indication to a network entity (NE), a network (NW) and/or a gNB associated with one or more actions (e.g., extended reality (XR) actions).

In certain representative embodiments, the UE may send higher/application-layer information to the NE, the NW and/or the gNB associated with itself and a collaborative UE and/or the collaborative UE group.

In certain representative embodiments, the UE may send the information and/or the indication to the NE/NW/gNB and/or other UEs (e.g., in the collaborative group), for example to enable periodic/dynamic allocations of resources in the collaborative UE group.

In certain representative embodiments, the UE may receive information and/or an indication from the NE/NW/gNB and/or other UEs (e.g., in the collaborative UE group), for example to enable periodic/dynamic allocations of resources in the collaborative UE group.

In certain representative embodiments, the UE may perform actions/behaviors associated with coordinated transmissions/reception in the collaborative UE group.

In certain representative embodiments, the UE may determine the information and/or the indication to be sent in the uplink (UL) based on the information or indication received in the downlink (DL).

In certain representative embodiments, the UE may receive, e.g., from a gNB/NW, configuration on allowable changes to resource grant configuration(s) for itself and member UE(s), which the UE can make and/or activate without indication to the gNB/NW. The UE may receive, e.g., from a gNB/NW, the corresponding thresholds to implement the allowable changes. The UE may inform a gNB/NW in the event that the changes are beyond what the gNB/NW configured as “allowable changes”.

### Example Procedure, for Example, for Supporting Coordinated Transmissions

In certain representative embodiments, a UE, e.g., an anchor UE, may be configured to receive configuration information from a gNB. The configuration information may include any of: IDs of one or more UE(s) in a collaborative UE group (e.g., Uu-link and SL IDs of anchor UE and member UE), default parameters of configured grants (CGs) associated with each UE in the group (e.g., start offset), time thresholds T1 and T2, and/or allowable changes to CG configurations (e.g., maximum duration allowed for time shifting the occasions of CG resources). In an embodiment, the anchor UE may be configured to receive, from higher layer, data and UE traffic association info between the anchor UE and member UE(s) (e.g. association flag). According to an embodiment, the anchor UE may be configured to determine UL jitter (o) for anchor UE and member UE(s) based on time of data arrival, default parameters of CG resources (e.g., start offset) of UEs, and/or traffic association information (e.g., traffic association information between anchor UE and member UE). In one embodiment, the anchor UE may be configured to determine whether to use the default CG configuration, a shifted CG, or request a new CG for itself and member UEs based on the value of jitter. For example, if δ<T1, then the anchor UE may determine to transmit UL data using CG resources with default parameters. If T1<δ<T2, then the anchor UE may determine to transmit data in UL using time shifted CG resources. If δ>T2, then the anchor UE may determine to transmit an indication to gNB to request resources for anchor UE and member UE, and to transmit data in UL using received resources. According to certain embodiments, the anchor UE may be further configured to transmit next data in UL using CG resources with default parameters.

Example Procedure (e.g., Realization), for Example, Using an Anchor UE that Coordinates Collaborative UE Group Scheduling

In certain representative embodiments, an anchor UE may receive higher/application-layer information about a XR experience (e.g., an expected periodicity of traffic, an average expected jitter associated with the XR experience, and/or other XR parameters, among others). The anchor UE may send assistance information to the gNB/NE associated with the higher/application-layer information. The anchor UE may receive assistance information from the gNB/NE, which may include at least one of the following: (1) a configuration/configuration information (e.g., in/for the radio resource control (RRC) related to the collaborative UE group (e.g., the UE IDs), (2) one or more pre-configured sets of resource grants for each UE out of which at least one is activated (e.g., one or more configured grant (CG) sets may be activated), and/or (3) an overall threshold T that may trigger a change in one or more resource grant allocations. The anchor UE may receive an indication of an event from an application and a duration of the event (e.g., an expected time window). The anchor UE may receive data from the application. The anchor UE may determine an absolute time difference (δ) resulting from the event based on a time-of-arrival (e.g., a time stamp or other time indication) of data from the application and resource grant configurations of first and second UEs (e.g., UE A and UE B) (e.g., CG configurations). For example, if δ<Threshold T, the anchor UE may send data using the activated resource grant. As another example, if δ>Threshold T, the anchor UE may select a most appropriate resource grant configuration for itself and UE B by considering δ (e.g., based on δ). The anchor UE may send an indication to the gNB/NE to select a different resource grant configuration out of a pre-configured list for the UE A and for a duration of the event. The anchor UE may send an indication/information to the gNB/NE on behalf of the UE B to select a different resource grant configuration out of the pre-configured list for the UE B. In certain representative embodiments, the anchor UE may send an indication/information to the UE B (e.g., via a sidelink (SL) transmission/direct communication), for example to signal an adjustment of a resource grant allocation cycle. In certain representative embodiments, the gNB/NE may send a wake-up signal (WUS) to indicate a change. The anchor UE may receive from the gNB/NE any of: (1) a resource grant confirmation for the UE B and/or (2) a resource grant activation for the UE A.

Example Procedures, for example, using a Collaborative UE to Assist in Coordination of a Collaborative UE group

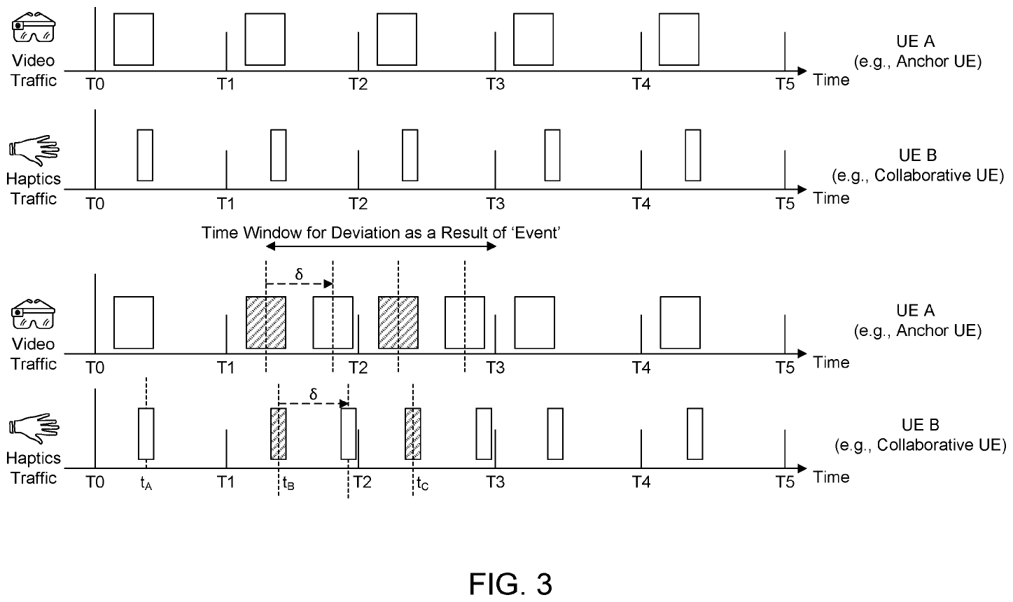

In certain representative embodiments, a collaborative UE may receive a configuration/configuration information from a NE/gNB. The configuration information may include or indicate: (1) one or more sets of resource grants; (2) one or more activated sets/resource grants and/or (3) one or more monitoring occasions, (e.g., the onset and/or duration of the monitoring occasions, for example one or more time-related values (for example associated with a timer) to define the one or more monitoring occasions. The collaborative UE may receive data from an application. The collaborative UE may send data at a first time t_{A} (e.g., as shown in FIG. 3) and may start a timer (e.g., start a time expiration operation based on a time value) associated with the activated resource grant.

At expiry of the timer (e.g., end of the expiration operation), at the second time t_{B}, (e.g., as shown in FIG. 3), the UE may start to monitor the DL (e.g., the Physical Downlink Control Channel (PDCCH transmission). On condition that or if the UE receives an indication/information from the NE/NW/gNB to change the resource grant from the NE/gNB, the UE may switch to another resource grant from the initial set or pre-configured resource grants. On condition that or if the UE receive no DCI, the UE may restart the timer (e.g., restart the time expiration operation) for monitoring occasions.

The term “extended Reality” (XR) is an umbrella term for different types of immersive experiences including Virtual Reality (VR), Augmented Reality (AR) and Mixed Reality (MR) and the realities interpolated among them. Virtual Reality (VR) is a rendered version of a delivered visual and audio scene. The rendering may be designed to mimic the visual (e.g., stereoscopic 3D) and audio sensory stimuli of the real world as naturally as possible to an observer or user as they move within the limits defined by the application. Augmented Reality (AR) may be when a user is provided with additional information or artificially generated items and/or content overlaid upon their current environment. Mixed Reality (MR) may be an advanced form of AR where some virtual elements may be inserted into a physical scene, for example, with the intent to provide the illusion that these elements are part of the real scene. XR may allude to (e.g., be associated with) real and virtual (e.g., all real-and-virtual) combined environments and human-machine interactions generated by computer technology and wearables.

The notion of immersion in the context of XR applications/services refers to the sense of being surrounded by the virtual environment as well as providing a feeling of being physically and spatially located in the virtual environment. The levels of virtuality may range from partial sensory inputs to fully immersive multi-sensory inputs leading to a virtual reality practically indiscernible from actual reality.

XR devices may be typically associated with capabilities that offer various degrees of spatial tracking. XR devices may be equipped with various sensors, for example, to enable spatial tracking, for example monocular/stereo/depth cameras, radio beacons, GPS, and/or inertial sensors, among others. Such spatial tracking may be performed at different levels, e.g., 3 Degrees of Freedom (DoF) (rotational motion along X, Y and Z axis), 6 DoF (rotational and/or translational motion along X, Y and Z axis). Such spatial tracking may result in an interaction to experience some form of virtual content. The user may act in and/or interact with the components within extended reality. For example, the actions and/or interactions may involve movements, gestures, and/or eye tracking, among others. Spatial tracking may be an enabler (important enabler) for an immersive XR experience. For example, some form of head and/or motion tracking may ensure that the simulated visual and audio components from the user perspective are updated to be consistent with user's movements. Imprecise and/or delayed spatial tracking may lead to sensation of discomfort and/or motion sickness for the user.

A UE may correspond to any XR device/node which may come in a variety of form factors. A typical UE (e.g., an XR UE) may include, but is not limited to any of the following: (1) one or more Head Mounted Displays (HMDs), (2) optical see-through glasses and camera see-through HMDs for AR and MR, (3) one or more mobile devices with positional tracking, (4) cameras, and/or (5) wearables, among others. In addition to or in lieu of the above, several different types of XR UEs may be implemented based on XR device functions/operations, for example using or including any of: (1) one or more displays, (2) one or more cameras, (3) one or more sensors, (4) sensor processing, (5) wireless connectivity, (6) XR/Media processing, and/or (7) one or more power supplies, among others to be provided by any of: (i) one or more devices, (ii) one or more wearables, (iii) one or more actuators, (iv) one or more controllers and/or (v) one or more accessories.

One or more device/nodes/UEs may be grouped into a collaborative group (e.g., XR group) for supporting an application (e.g., any of XR applications/services and/or timing/synchronization operation. For example, the procedure may use both networked communication and sidelink (e.g., direct UE-to-UE communication) to enable time synchronization between a first UE/device and a second UE/device.

### Representative Traffic Models for XR Applications/Use Cases

### First Representative Virtual Reality (VR1) Applications

First VR1 applications (e.g., streaming of immersive using 6DoF) may be modeled using service flows applicable for viewport dependent streaming architectures. Similar to adaptive streaming (e.g., DASH), viewport dependent streaming may allow for dynamically updating the quality of media/video based on available bitrate in the network and the wireless interface. As for the service/traffic flow, tracking and pose information (e.g., with a small packet size: <100B) of the viewport of the XR device may be sent periodically with a data rate (e.g., relatively low data rate) (e.g., of 0.5-2 M Bits per second (Bps), at 60 to 500 Hz) in the UL to an XR server. In response, the XR server may send in the DL with a data rate (e.g., higher data rate) (e.g., 6-18 Mbps for 4k omnidirectional and/or Field of View (FoV) area streaming) and/or periodical (for example, quasi-periodically (e.g., at 40/60/120 frames per second (fps)). For example, the viewport may be optimized media adaptively (e.g., H.264/265 video), which may then be rendered in an XR device display.

For example, the traffic characteristics of the VR1 application may be as follows. For instance, for the UL pose/viewport information (e.g., including information on the 6DoF), the traffic characteristics may: (i) include packets of a small size (e.g., constant size <100B), (ii) have a data rate (e.g., low data rate) of about 0.5-2 Mbps, (iii) use a single flow, and/or (iv) be periodic (e.g., in a periodicity range of 60 to 500 Hz). Additionally or alternatively, for the DL, media/video may contain or include a viewport optimized scene (e.g., a high quality viewport optimized scene) and media/video for non-viewport scene (of a lower quality). For example, for the DL, the traffic characteristics may: (i) include packets of a large size (e.g., variable size with Gaussian distribution or fixed size of 1500B), (ii) use a high data rate of about 6-18 Mbps, (iii) have an end-to-end (E2E) latency in the range of 50 ms, (iv) use multi-flow (e.g., video flows with different bit-rates, 3D media, and/or metadata, among others), and/or (iv) be semi-periodic (e.g., quasi-periodic (for example with a periodicity as a function of frame rate of 40/60/120 fps).

### Second Representative Virtual Reality (VR2) Applications

The VR2 applications (e.g., an immersive game in spectator mode) may be modeled using service flows which are applicable to a split rendering architecture. In this case, the XR server may perform pre-rendering and encoding of a two-dimensional (2D) media/video frame based on the pose information sent by the XR device periodically at a first data rate (e.g., a low data rate such as 0.5-2 Mbps, at 60-500 Hz). The rendering may be performed (e.g., mainly performed) in the XR-server and may be sent in the DL at a higher data rate (e.g., a rate above a threshold) and/or with a latency (e.g., a low latency, for example of 30-45 Mbps, for 10-20 ms). The XR device may decompress the received media/video and may perform asynchronous time-warping (ATW) for correcting the viewport based on latest pose information. While the round trip time (RTT) latency for transmission of the pose information in the UL and reception of pre-rendered media in the DL may span up to 50 ms, the ATW may enable satisfaction of a motion-to-photon latency requirement (e.g., of <20 ms) based on in-device processing.

For example, the traffic characteristics of VR2 may be as follows. For instance, for the UL pose/viewport information, the traffic characteristics may: (i) include packets of a small size (e.g., constant size <100B), (ii) have a data rate (e.g., low data rate of about 0.5-2 Mbps, (iii) use a single flow, and/or (iv) be periodic (e.g., in a periodicity range of 60 to 500 Hz). Additionally or alternatively, for the DL, 3D scenes may be provided in frame buffers. For example, the traffic characteristics may: (i) include packets of a large size (e.g., with Gaussian distribution, e.g., in a range of about max 1500B or unlimited), (ii) use a high data rate of about 30-45 Mbps, (iii) have a RTT latency of about 30 ms (e.g., average or typical) and RTT max of about 50 ms), (iv) use multi-flow (e.g., 3D video/media and/or metadata) and/or (v) be quasi-periodic (e.g., periodicity may be as a function of frame rate of 60/90 fps).

### First Representative Augmented Reality 1 (AR1) Applications

The AR1 applications (e.g., real-time communication with shop assistant) may be characterized using service flows applicable to distributed computing architectures. As per the service and/or traffic flow, the XR device may send the pose information (e.g., 0.5-2 Mbps, at 60-500 Hz)) and/or video (e.g., 10 Mbps, at 10 Hz frame update rate) in the UL to the XR server. The received information may be used by the XR server to generate a scene, which may be a converted 2D (e.g., video) or 3D media (e.g., 3D objects) format along with metadata (e.g., of a scene description). The compressed media and metadata (e.g., which may be characterized by a Pareto distribution) may be delivered quasi-periodically in the DL at a high data rate (e.g., 30-45 Mbps, at 40/60/120 fps). The XR device may generate the AR scene locally, for example, by overlaying 3D objects on a 2D video, and may render the scene in the device display.

For example, the traffic characteristics of AR1 may be, as follows. For instance, for the UL pose information and/or 2D video stream information, the pose traffic characteristics may: (i) include packets of a small size, (ii) have a data rate (e.g., low data rate of about 0.5-2 Mbps) and/or (iii) be periodic in a range of about 60 to 500 Hz. For example, the video traffic characteristics may: (i) include packets of a large size, (ii) have a data rate (e.g., of about 10 Mbps) and/or (iii) be periodic (e.g., with update periodicity of 10 Hz). Additionally or alternatively, for the DL 2D/3D pre-rendered media and XR metadata, the traffic characteristics may: (i) include packets of a large size (e.g., with a Pareto distribution), (ii) use a high data rate, e.g., of about 30-45 Mbps, (iii) use multi-flow (e.g., 2D/3D media and/or metadata) and/or (iv) be quasi-periodic (e.g., periodicity may be as a function of frame rate of 60/90 fps).

### Second Representative Augmented Reality (AR2) Applications

The AR2 applications (e.g., XR meeting, and/or AR animated avatar calls) may use service/traffic flows applicable for XR conversational architectures in which two or more XR clients/devices may perform peer-to-peer communications with intermediary media processing in the network. The different types of media that may be supported for AR2 applications, based on the type of user representation, include 2D+/RGBD (e.g., at 2.7 Mbps), 3D mesh (e.g., at 30 Mbps) and/or 3D Video point cloud coding (VPCC)/Geometry-based point cloud compression (GPCC) (e.g., at 5-50 Mbps). In typical XR traffic flows, an XR client in the device may initiate a call setup procedure, based on which session control function triggers network-based media processing. The session control function may forward the call setup to the second XR client/device followed by real-time media processing and/or streaming with a low latency (e.g., an E2E latency of about <100 ms) to both clients. During an XR call, the 2D/3D media, and possibly the user pose information, may be transmitted quasi-periodically in the UL and/or the DL between the XR clients/devices.

For example, the traffic characteristics of AR2 may be as follows. For instance, for the UL 2D/3D media, pose and/or video of user, the traffic characteristics may: (i) include packets of a large size, (ii) have a data rate (e.g., high data rate of about 2.7-50 Mbps), (iii) have a packet delay budget (PDB) of about <150 ms, (iv) use multi-flow (e.g., 2D/3D media), and/or (v) be quasi-periodic in a range of about 60 to 500 Hz. Additionally or alternatively, for the DL 2D/3D media, pose and/or video of user, the traffic characteristics may: (i) include packets of a large size (e.g., with a truncated Gaussian distribution), (ii) use a high data rate of about 2.7-50 Mbps, (iii) have a E2E PDB of about <100 ms, (iv) use multi-flow (e.g., 2D/3D media), and/or (v) be quasi-periodic (e.g., at about 60 to 500 Hz).

### Representative XR Conferencing Applications

XR Conferencing applications provide an immersive conferencing experience between geographically remote users by representing the users in a 3D volumetric representation (e.g., point clouds or meshes). One or more cameras (with depth perception capability) may be placed at each users' location to allow interactions (e.g., view, hear, rotate, zoom-in, and/or resize, among others) with a full 3D volumetric representation of one another on their respective headsets/glasses. XR Conferencing applications may support simultaneous UL and DL media traffic, with media consisting of/including audio, video and/or 3D objects. The media formats that may be applied to capture the user in 3D volumetric format may include 2D+/RGBD (>2.7 Mbps for 1 camera, and/or >5.4 Mbps for 2 cameras), 3D Mesh (˜30 Mbps) and/or 3D VPCC/GPCC (at about 5-50 Mbps). The media processor may be located centrally or distributed at the edge of the network. The service/traffic flows between the XR clients/users via the in-network media processor may be expected to be similar to the AR2 and XR conversational use cases. Joining an XR conference session may result in a download peak at the beginning for downloading the virtual environment and associated media objects within the XR application. Throughout the rest of the session, data rates may vary depending on number of users, upload format of the users, and refresh rates of virtual 2D/3D objects/environment.

For example, the traffic characteristics of XR Conferencing may be as follows. For instance, for the UL 2D/3D media, pose and/or real-time video of user, 2D/3D objects/environment (possibly from third party), the traffic characteristics may: (i) include packets of a large size, (ii) have a data rate (e.g., high data rate of about 2.7-50 Mbps (iii) use multi-flow (e.g., 2D/3D media), (iv) be quasi-periodic in a range of about 60 to 500 Hz and/or (v) have a low encoder packet error rate (PER) of about <10⁻³. Additionally or alternatively, for the DL 2D/3D media, pose and/or real-time video of user, 2D/3D objects/environment (possibly from third party), the traffic characteristics may: (i) include packets of a large size, (ii) have a data rate (e.g., high data rate of about 2.7-50 Mbps), (iii) E2E PDB of about <100 ms, (iv) use multi-flow (e.g., 2D/3D media), (v) be quasi-periodic in a range of about 60 to 500 Hz, and/or (vi) have a low encoder PER of about <10⁻³.

### Representative Cloud Gaming Applications

Cloud gaming applications (e.g., 5G online gaming) predominantly rely on adaptive streaming architectures where the rendered video/media in the network is streamed to a thin client in the device (e.g., a smartphone, and/or a tablet). In a typical service/traffic flow for cloud gaming, the XR device may send the pose information (e.g., at about 100 to 250B) related to viewport periodically in the UL (e.g., at about 0.1-1 Mbps, and at 60-500 Hz) to the XR server. The generated viewport-related video/media (e.g., about 1500B) may be encoded/compressed (e.g., via H.264/265 video) and may be sent quasi-periodically by the XR server in the DL (e.g., at about 30-45 Mbps, with 30/50/60/90/120 fps, and a PER: of about or less than 10e−3). The received video/media may be rendered in the XR device upon decoding and processing. The RTT latency for supporting certain high-end cloud gaming applications (e.g., Category D applications such as photo-realistic and/or natural video games) may be determined by a roundtrip interaction delay (e.g., of about 50 ms or less). For other cloud gaming applications (e.g., Category A, B, or C applications), the UL PDB may be about 10 ms and the DL streaming PDB may range from about 50 ms to 200 ms. The traffic characteristics of cloud gaming are as follows, for example:

For example, the traffic characteristics of cloud gaming may be as follows. For instance, for the UL pose/viewport information, the traffic characteristics may: (i) include packets of a small size (e.g., of about 100 to 250B), (ii) have a data rate (e.g., low data rate of about 0.1-1 Mbps, (iii) have a PDB of about 10 ms, (iv) use a single flow and/or (v) be periodic in a range of about 60 to 500 Hz. Additionally or alternatively, for the DL 2D/3D media and/or video of user, the traffic characteristics may: (i) include packets of a large size (e.g., of about a max 1500B), (ii) use a high data rate, e.g., of about 30-45 Mbps, (iii) have a PDB of about 2 ms, (iv) use multi-flow (e.g., 2D/3D media and/or video), (v) be quasi-periodic (e.g., periodicity may be as a function of frame rate of 30/60/90/120 fps), and/or (vi) have a PER of about or less than 10e−3.

As disclosed herein, the network may include network entities (NEs) including any of one or more base stations (e.g., gNBs, transmission/reception points (TRPs), radio access network (RAN) nodes, and/or access nodes), one or more core network functions (e.g., UPFs, SMFs and/or AMFs, among others) and one or more application functions (e.g., edge server functions, and/or remote server functions, among others), for example. As disclosed herein, flows may correspond to any of: QoS flows or data flows (e.g., flow of data or PDUs, which may be associated with one or more QoS requirements, e.g., latency, data rate, and/or reliability, among others).

As disclosed herein, a forwarding configuration may correspond to any of: (1) one or more radio bearers, (2) one or more logical channels, (3) one or more configuration parameters in individual layers within the access stratum (AS) protocol stack (e.g., the SDAP, PDCP, RLC, MAC, and/or PHY layers), (4) one or more parameters associated with logical channel prioritization (LCP) (e.g., a priority, a prioritized bit rate (PBR), and/or a bucket size duration (BSD)), (5) one or more parameters associated with mapping from data/QoS flows to radio bearers (e.g., parameters at the SDAP), (6) one or more carriers, (7) one or more Bandwidth Parts (BWPs), and/or (8) one or more links, which may be used for delivering the PDUs in the UL direction and/or the DL direction, for example.

Multiple UEs/other devices may be associated with the same application/experience. For example, the degree of association may vary depending on application layer and/or access stratum (AS) layer attributes. In certain representative embodiments, collaborative UEs (e.g., each collaborative UE) may handle scheduling collaboratively, for example to reduce misalignment when individual radio resource grants are requested and received.

In certain representative embodiments, the coordination/collaboration may be handled at a layer below the application layer, for example to reduce latency and/or overhead.

For example, providing the coordination and/or collaboration at the application layer to the AS layer may guarantee a latency (e.g., satisfy a packed delay budget requirement) for the user experience (e.g., XR experience).

In certain embodiments, handling coordination/collaboration at one of the UEs in a UE group may minimize signaling, for example, for one or more experiences. For example, signaling for multiple CG grant (e.g., modification) requests, and CSI on individual links may be reduced and/or minimized. Such coordination/collaboration, for example may enable streamlining transmissions and/or retransmissions in a coordinated way to increase reliability for an overall experience

A select set of devices and/or UEs with diverse capabilities and functions working collaboratively may contribute to one XR experience. In this regard, at least the following challenges are addressed herein: (1) how can one or more UEs support coordination in a collaborative UE group, for example, to ensure that data transmissions and/or receptions are handled in an efficient way; and (2) what are the corresponding actions and/or behaviors of the UEs in a collaborative UE group associated with user experience (e.g., XR experience).

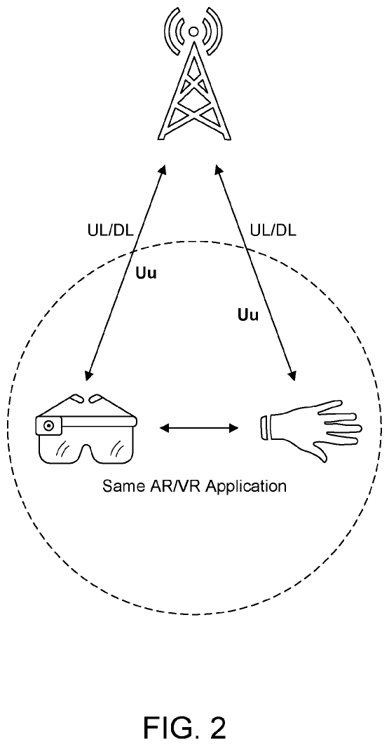

FIG. 2 is a diagram illustrating a set of UEs (e.g., UE A and UE B) that may form at least a part of a collaborative UE group taking part in a collaborative action (e.g., an ‘XR experience’).

FIG. 3 is a diagram illustrating an example of coordinated transmission in a collaborative UE group including an anchor UE (e.g., transmitting traffic such as video traffic), which may leverage knowledge of traffic of the collaborative UE (e.g., transmitting other traffic such as haptics traffic) to ensure proper offsets are applied (e.g., in a time window) during data transmissions.

### Overview of Collaborative XR

A collaborative group or collaborative UE group may comprise or include two or more UEs with a first UE designated as an anchor UE and a second UE designated as a collaborative UE.

For example, a UE may be one or more of the following: (1) one or more independent and/or stand-alone devices or nodes (e.g., XR device, XR glasses, smart watches); (2) one or more devices that may be user-centric (e.g., each may belong to or be registered to the same user) or non-user centric (e.g., devices may belong to or be registered to multiple users); (3) one or more UEs that may be linked and/or connected to one or more other UEs where that association between one or multiple UEs may have initiated at the application and may have permeated through to other layers of the communications framework (e.g., the NAS, the PDCP, the MAC, etc.); (4) non-standalone devices/nodes (e.g., where the devices are and/or may need to be associated with another device such as a UE, sensors, wearable devices, and/or haptics gloves, among others); (5) devices/nodes controlled by a network (e.g., a network operator); (6) devices/nodes that may not be directly associated with and/or connected to a NE/gNB and, for example may be a candidate and/or option for a collaborative group given certain parameters (e.g., FoV metadata (e.g., size, dimension, quality, etc. of FoV), and/or pose information); and/or (7) stationary, static, moving and/or mobile devices or nodes, among others.

The terms corresponding to any of UE, any node and/or any device may be used interchangeably and may refer to any of the different UE types described above.

An anchor UE, in the context of collaborative XR, may refer to any UE involved in performing any one or more of the following: (1) hosting of the application function (e.g., XR application) from which a request for any actions (e.g., XR actions) may be received; (2) receiving the request for an action (e.g., an XR action) from an application function located in the network (e.g., at an edge server and/or a remote server); (3) initiating a discovery procedure to determine other UEs/devices/nodes that are in proximity for performing any action (e.g., XR actions) in a collaborative UE group; (4) establishing a session (e.g., an XR session, a PDU session, and/or an application session) by sending and/or receiving a request for session establishment and may operate as the primary anchor point to communicate with a RAN function/node (e.g., gNB), a core network (CN) function and/or an application function (the session establishment may include sending and/or receiving any of session related messages, e.g., capability transfer information, assistance information transfer, configuration transfer information, measurement info, XR action status info, session activation/deactivation information, and/or session release information); (5) interfacing between the anchor UE and the network (for example, when supporting a connection to the network, an interface between the anchor UE and the network (e.g., the NE, the base station and/or the gNB) may be referred to as a primary Uu link); (6) coordination (for example, the anchor UE may support coordination between or among the anchor UE and the one or more collaborative UEs during an event (e.g., an ‘XR experience’), irrespective of the level of association that there may exist between or among the anchor UE and the collaborative UEs for the XR experience. The level of association may stay constant or vary throughout the experience); and/or (7) communication of (e.g., providing) assistance information to the network (NW) for coordinating the collaborative UE group (e.g., timing (e.g., expected timing) of transmissions, duration of transmissions, etc. on behalf of the anchor UE and the one or more collaborative UEs).

A collaborative UE, which may be interchangeably referred to as member UE, in the context of collaborative XR, may refer to any UE involved in performing one or more of the following: (1) initiating a discovery procedure and/or receiving a request for making the UE discoverable (e.g., via sidelink and/or via the network) to perform one or more action (e.g., XR actions); (2) interfacing (for example when supporting a connection to the network, the interface between the collaborative UE and the network (e.g., a NE/base station and/or gNB) may be referred to as a secondary Uu link); (3) sending information related actions (e.g., XR actions, such as pose info, FoV parameters including direction, width of FoV, and other FoV metadata, UP data containing the captured/mapped FoV content and/or media/video frames, assistance info, and/or status info, among others) to the network (e.g., directly to the network, such as to the gNB/NE/base station, a CN function, and/or an application function) and/or indirectly to the anchor UE; (4) receiving information (e.g., RRC configuration info, and/or application configuration info, among others), for example which may be used for determining any of the actions (e.g., XR actions), possibly along with anchor UE; (5) sending action (e.g., XR action) related messages/reports to the anchor UE and/or the network (e.g., a NE), for example, including pose and/or FoV measurements and estimates over sidelink interfaces (e.g., NR sidelink, Bluetooth, and/or WiFi Direct, among others); and/or (6) collaboration, (for example, a collaborative UE may be associated with different collaborative groups and anchor UEs).

The end user/XR experience relates to the overall experience of the end user, resulting from coordinated transmission and/or reception of the correct data to the correct end device in a reliable and timely manner.

An action (e.g., XR action) may be divided amongst and/or be performed by one more UEs, where an anchor UE may perform dividing of the action (e.g., XR action) and/or coordination with the other UEs in a collaborative UE group for performing the divided action. In another example, the same/similar action (e.g., XR action) may be performed by one or more UEs/nodes associated with a collaborative group, where the action (e.g., XR action) may be performed in parallel.

Although various embodiments are described using XR implementations and operations, embodiments are not limited thereto, and other implementations are equally possible. Coordinated actions between devices may be implemented for wearable devices, gaming devices, AR/VR devices, and other IoT devices, for example that could benefit from a coordinated/collaborative control scheme.

An ‘event’ may, for example, result in a change in the current mode of operation, transmission, and/or reception of data that may require or use a change in resource allocations, statically, semi-statically or dynamically (e.g., a change in the resource grant allocations, a change in periodicity of configured grants, and/or an application of an offset to the resource grant allocations, among others). Examples of when an event or triggering condition may be detected may include any one or more of the following: (1) the anchor UE may receive an indication from the application of an expected delay, for example, as a result of jitter in the UL (e.g., as a result of processing delay from the codec in the AR glasses and/or VR headset); (2) the anchor UE may detect the presence of jitter exceeding a threshold (e.g., an allowed delay budget) based on reception of a previous DL transmission; (3) the anchor UE may receive an indication from the application regarding the experience (e.g., XR experience) and the associated payload (e.g., an increase in resources following an anticipated change in scenery that would be known by the application and indicated to the anchor UE) or, in other representative embodiments, the experience/payload may be detected implicitly by the anchor UE (e.g., from an increase in data rate); (4) the anchor UE may receive dynamic indications either implicitly or explicitly (e.g., regarding the priority/importance of the data, and/or spatial/pose info, among others) from one or more collaborative UEs in the collaborative group (e.g., as application type events) and/or from the application; and/or (5) the anchor UE may receive an indication from the gNB/NE on a change in one or more lower layer parameters (e.g., a degradation in link quality, a coverage hole, and/or a cell edge, among others).

Detection of an event and/or triggering condition may be based on timing of an arrival of data from the application being outside of the expected window-of-arrival, based on measurements by the UE. This may lead the UE to alter a mode of resource grant allocation.

The terms related to anchor UE and collaborative UE are non-limiting examples. Other terms may be used interchangeably when referring to an anchor UE (for example ‘central UE’, ‘primary UE’, ‘main UE’, ‘initiating UE’, ‘UE 1’, and ‘UE A’, ‘first UE’, among others. Other terminologies that may be used when referring to collaborative UE may include ‘assisting UE’, ‘supporting UE’, ‘secondary UE’, ‘second UE’, ‘UE 2’, ‘UE B’, among others.

### Representative Procedures for Supporting Coordinated Transmissions/Receptions for UEs in a Collaborative UE Group

Procedures described herein may occur in a semi-static and/or dynamic manner, once or multiple times, at the start and/or throughout the experience/action (e.g., XR experience/XR action).

### Representative ID Management Procedures for Association Between/Among UEs

Identifiers (IDs) may be implemented/used for associating UEs in a collaborative UE group. For example, an anchor UE and one or more collaborative UEs may be associated and a level of such an association may vary from one experience, action, and/or trigger condition (e.g., XR experience) to another and/or within the same experience/action or after one triggering condition is met (e.g., XR experience). The association between and/or among UEs in the collaborative UE group may initiate from the application and follow the requirements of the application, for example, to offer the experience (e.g., XR experience), and the association may permeate through and/or translate to other layers in the communications framework (e.g., the NAS, RRC, SDAP, PDCP, RLC, MAC, and/or PHY layers or any new layer of the AS protocol stack).

The initial ID from the application may be retained throughout the layers or there may be different IDs generated in the different layers and an association may be made between the corresponding IDs within each layer. The IDs may remain the same throughout the experience (e.g., XR experience). The IDs may remain the same from one session (e.g., XR session) to another, or the IDs may change during a session and/or between sessions. For example, management and/or storage of the IDs between/among the UEs in the collaborative UE group may be done by: (1) the CN, (2) the gNB/NE, (3) the application, and/or (4) the UEs involved in the XR experience.

Service IDs and one or more XR action IDs may be matched. For example, a UE may send one or more IDs including any of the following: (1) an application ID, (2) a service ID, (3) a session ID, (4) a UE ID, (5) a collaborative group ID, and/or (6) a XR action ID (e.g., XR actions supported by UE and/or requested to be performed by other UEs). In certain embodiments, a collaborative UE may send an indication when detecting that a service ID/XR action ID in the discovery, solicitation, and/or indication message received from an anchor UE matches that of the service ID and/or XR action ID pre-configured and/or available in the collaborative UE.

For example, the IDs associated with one or more UEs (e.g., UE IDs and/or Cell Radio Network Temporary Identifier (C-RNTI) in a collaborative UE group and/or the ID associated with the collaborative UE group, e.g., group RNTI) may be used in any UP/CP procedures (e.g., scheduling), including: (1) when sending RRC messages, Service Requests (SRs)/Buffer Status Reports (BSRs), Uplink Control Information (UCI), UL Medium Access Control Control Elements (MAC CEs), PUCCH transmissions, PUSCH transmissions, UE data and/or assistance data, among others, and/or (2) when receiving RRC signalling/messages, resource grants, configured grants, a DCI, DL MAC CEs, PDCCH transmissions, and/or PDSCH transmissions, among others.

According to certain embodiments, matching capability and/or procedure may be implemented. For example, the collaborative UE may send an indication when determining that the one or more capabilities (e.g., XR capability and/or connectivity capability) currently supported are within the capability of the collaborative UE (e.g., to support matches with those indicated by the anchor UE in the discovery/solicitation/indication message).

Representative Procedures for Sending Information Associated with Coordination/UE Actions

A UE may send information and/or an indication to the network (e.g., a NE) associated with one or more XR actions. In certain embodiments, the UE may send information to the network, and the information may be associated with one or more XR actions performed by the UE. In certain examples, the UE may send the information associated with the XR actions for assisting the scheduler in the network to schedule task and/or for requesting network resources on a per-group basis. In other examples, the UE may send the information for supporting application awareness feature in the network, for example, to enable the network to have awareness of the XR actions and/or application attributes/parameters supported by the UE.

The information may be sent by the UE to the network as any of the following: (1) assistance information, (2) status information/a status indication, and/or (3) request/response messages, for example. The UE may send the information to the network via: (1) AS layer signaling (e.g., RRC signaling and/or messages, using a MAC CE and/or via UCI), (2) Non-AS (NAS) layer signaling (e.g., PDU session related messages), and/or (3) application layer signaling/messages, for example.

In example embodiments, the information sent by the UE (e.g., the anchor UE or other UEs) for example, may include any one or more of the following:
(1) identifiers/IDs (for example, the UE may send one or more IDs including any of the following: an application/service/session ID, a collaborative group ID (e.g., in which the UE may be associated with), IDs of other UEs/nodes, and/or an XR action ID (e.g., XR actions supported by the UE and/or requested to be performed be other UEs) and/or a data type/message ID (e.g., an ID associated with pose info, FoV info, and/or media/video frame info, among others)),
(2) pose information (e.g., orientation, and/or position (for example, the pose information may be associated with measurements in any spatial dimensions, including but not limited to longitude, latitude, altitude, roll, pitch and/or yaw in one or more coordinate systems (e.g., cartesian and/or spherical). In certain examples, the pose information sent by the UE may be associated with the orientation and/or position/location of the UE. In other examples, the pose information sent by the UE may be the orientation and/or position/location of another UE/node/device, which may be desired and/or requested by the UE);
(3) Capability information associated with connectivity (for example, information on interfaces that may include a number of interfaces and/or types of interfaces (e.g., NR Uu, NR SL, WILAN, and/or Bluetooth, among others), supported by the UE within the collaborative UE group. For example, the capability information on interfaces, possibly supported by UE and/or required/used by the UE for supporting any of the XR actions in other UEs, may include any of the following: (i) bandwidth, (ii) number of carriers, (iii) number of transmit antennas, and/or (iv) number of receive antennas, among others);
(4) Capability information associated with XR actions (for example, the capability information related to XR actions, including visual sensing, possibly supported by the UE (e.g., sensors, camera associated with UE) and/or required/used by the UE for supporting any of the XR actions in other UEs, and may include any of the following: (i) FoV resolution (e.g., a megapixel count), (ii) aperture size, (iii) shutter lag, (iv) startup time, (v) image quality (e.g., min/max range), (vi) zoom lens options, (vii) image stabilization, (viii) exposure settings, (ix) battery life, (x) sound/audio, and/or (xi) a capability to merge overlapping frames from different angles (e.g., stitching frames from individual captures together for panoramic image/video); and/or
(5) One or more preferred forwarding configurations (for example, the UE may send to the network/NE and/or other UEs/nodes one or more preferred forwarding configurations for supporting any XR action that may be performed/supported by a collaborative UE and/or another UE/node on behalf of the UE. For example, the one or more forwarding configurations sent by the UE associated with the supported and/or requested UP/CP configurations (e.g., radio bearers, logical channels, and/or links) may include any of: (i) latency requirements (in a first example, the latency requirements may be expressed in terms of PDB associated with IP packets/PDUs. In a second example, the latency requirements may be expressed in terms of an Application Delay Budget and/or a Frame Delay Budget associated with frames (e.g., video/media frames)); (ii) data rate requirements (e.g., Mbps); (iii) reliability requirements (in one example, the reliability may be expressed in PER. In another example, the reliability may be expressed in Frame Error Rate and/or Application Error rate); (iv) absolute/relative priority values associated with the UP/CP configurations (e.g., radio bearers, logical channels, and/or links)).

For example, the UE may send the first two or the first three or the first four preferred QoS configurations to provide options for the selection (e.g., best selection) of resource grant allocations for the UE in the event in which the network/gNB/NE may be the entity selecting the resource grant configuration (e.g., best resource grant configuration) for the anchor UE and/or the one or more collaborative UEs in the collaborative UE group.

The UE may send to the network/NE the information, possibly associated with XR actions and/or the collaborative group, based on one or more of the following triggering events/trigger conditions: (1) during connectivity/session establishment, configuration and/or reconfiguration (for example, during RRC connection, PDU session, application session establishment configuration and/or reconfiguration; (2) when changing and/or updating XR actions (for example, when new XR actions occur and/or when releasing XR actions); (3) when receiving higher layer information and/or application information (for example, when receiving an indication (e.g., from the application function hosted in the UE or hosted in the network) indicating a change in the XR actions, and/or the forwarding configurations, among others); (4) when detecting one or more changes in measurements and/or movements (for example, when the RSRP, RSRQ, and/or RSSI measurements of the signals, channels, radio links, and/or carriers, among others, possibly associated with the one or more XR actions, are above/below threshold values (e.g., to satisfy a triggering condition/threshold). As another example, when pose/positioning measurements (e.g., location information, and/or pose information in 6DoF) are above/below one or more pose threshold values; and/or (5) when detecting one or more changes in time/timing attributes (for example, the UE may send information periodically, aperiodically and/or when a timer associated with sending of assistance information is set (e.g., a time period starts) and/or expires (e.g., the time period end).

The UE may send higher and/or application-layer information to the network/NE/gNB associated with the UE, the one or more collaborative UEs and/or the collaborative UE group.

The UE may send assistance information on or via higher layer information and/or via application layer information to the network/NE/gNB. The assistance information may include any parameters from the application that may assist the gNB in scheduling tasks for the anchor UE and/or for the one or more UEs in the collaborative UE group. Such examples may include, but not limited to: (1) information about the traffic, (for example, information regarding packet size, expected arrival of PDUs and/or a group/cluster/burst of PDUs); (2) expected periodicity of the traffic; (3) average expected jitter of the traffic; and/or (4) one or multiple thresholds associated with the XR experience/XR application that may require/use the triggering of a different resource grant allocation/configuration for the anchor UE and/or one or more collaborative UEs as part of the collaborative UE group.

The UE may send information and/or an indication to the network and/or one or more other UEs, for example, to enable periodic/dynamic allocation of resources in the collaborative UE group.

In certain representative embodiments, periodic allocations of resources to one or more UEs in the collaborative UE group (e.g., a configured grant type may be used in the UL) may be implemented.

In various representative embodiments, dynamic allocations of resources to one or more UEs in the collaborative UE group (e.g., a dynamic grant type may be used in the UL) may be implemented.

To enable such embodiments disclosed herein, any of the following may occur. On condition that the network (e.g., a NE) selected a resource grant configuration for the anchor UE and/or the one or more collaborative UEs, which the anchor UE determines is not the most appropriate resource grant configuration for the anchor UE and/or the one or more collaborative UEs, the anchor UE may send an indication to the NE/gNB/base station to change the resource grant configuration. For example, the anchor UE may: (i) select a different resource grant configuration from a pre-configured set of resource grant configurations for the anchor UE and/or the one or more collaborative UEs; (ii) request the NE/gNB/base station to alter/modify/tweak the active resource grant configuration for the anchor UE and/or the one or more collaborative UEs (e.g., the modification may include a different periodicity, a different length, and/or a different volume of traffic, among others); and/or (iii) request the NE/gNB/base station to apply an offset (e.g., in subcarriers and/or in time/slots/symbols) to the active or upcoming resource grant configuration for the anchor UE and/or the one or more collaborative UEs.

The anchor UE may send to one or more collaborative UEs (e.g., via a direct/sidelink (SL) communication) an indication to signal an adjustment of the resource grant allocation (e.g., on condition that the anchor UE selected an alternate resource configuration for the one or more collaborative UEs or altered the active resource configuration for the one or more collaborative UEs (e.g., by applying an offset)).

The anchor UE may send an indication to any collaborative UE in the collaborative UE group to indicate when to listen/monitor for a DL transmission via a DL control channel (e.g., a PDCCH transmission) on condition that the anchor UE has requested a change and/or offset to the resource grant allocation for the collaborative UE. The indication may contain/include more granular information to find/locate/listen/monitor for upcoming transmissions (e.g., the anchor UE may indicate a specific frequency range, bandwidth part and/or search space set, etc.). The anchor UE may indicate/send a message to the collaborative UE that the NE/gNB/base station (BS) may send a low-power signal (e.g., a WUS) with the information (e.g., all the information) required/used for the one or more collaborative UEs and may indicate a window in which to expect/monitor for the low-power signal from the NE/gNB/BS.

In certain representative embodiments, the anchor UE may send and/or may be configured to send periodic indications to the one or more collaborative UEs regarding the status of the resource grant allocations for the anchor UE and/or the one or more collaborative UEs (e.g., the status may be per collaborative UE and/or a group status) in the collaborative UE group.

The collaborative UE may send dynamic and/or periodic indications to the anchor UE (e.g., via direct/SL communications) to request a change in resource grant configuration of the collaborative UE. The indications may be a request (e.g., simple request) to review the active resource grant allocations (e.g., active configured grant configuration, e.g., the periodicity and/or bitrate, among others) and/or a request to switch to a different resource grant configuration which may have been pre-approved by the NE/network.

The anchor UE may dynamically indicate a change in the UL traffic requirements based on the collaborative UE group by sending messages/indications to the NE/gNB/network. The network may use the received information to change how the network provides UL resources to the anchor UE and the collaborative UE group.

In certain examples, the anchor UE may initiate a SR/BSR based procedure to secure sufficient UL grants (e.g., PUSCH resources) based on current data requirements/needs/usage of the collaborative UE group. Various factors may influence the grant size including: (i) volume of data that is to be and/or needs to be served in the UL, for example, the FoV of devices in the collaborative UE group, (ii) channel conditions, (iii) link quality, (iv) communication range, (v) power requirements; and/or (vi) location of the UEs in collaborative UE group, among others. The UE may send a BSR to the NE/gNB/network which may be a joint BSR based on requirements of the UEs (e.g., some or all the UEs) in the collaborative UE group or an individual BSR (e.g., per UE BSR) based on each separate collaborative UE in the collaborative UE group.

In certain representative embodiments, a change in logical channel group (LCG) characteristics, as determined/observed from the anchor UE perspective, may result in a BSR MAC-CE being triggered from the anchor UE, which may occur if there are multiple LCGs with a change in traffic activity durations. For example, first video may be linked to a particular LCG (LCG ‘A’) and a higher priority video (e.g., with FoV data) may be linked to another higher priority LCG (LCG ‘B’). LCG ‘B’ may be bursty compared to LCG ‘A’, and sudden availability of data belonging to LCG ‘B’ may trigger a BSR report.

In certain representative embodiments, the anchor UE may be triggered to provide a BSR report, if the application at the anchor UE determines/detects/notices a degradation in a quality metric (e.g., a Quality of Experience (QoE) metric). The BSR may be triggered from a NE/gNB (e.g., the network side) based on feedback from the application server (e.g., the XR application server). The trigger may pre-empt a BSR from the anchor UE (e.g., from the anchor UE side). The network triggered BSR may result in an additional and/or simultaneous trigger of individual BSR from (one, a subset, or all) UEs/devices in the collaborative group of the anchor UE. The triggered BSR may remain active for some duration (e.g., based on a timer/counter/time value) or based on when the quality metric (e.g., QoE metric) for the application is satisfactory and/or restored. The quality metric may be measured (e.g., directly measured) at the anchor UE and/or may be based on feedback received from the NE/gNB and/or the application server (e.g., XR application server).

In certain representative embodiments, the anchor UE may send a power headroom (PH) report to the gNB/NE/network. The PH report may be triggered by expiration of a timer (e.g., at the end of a time period) and, for example, may be a periodic report timer). The PH report may be triggered if the anchor UE detects a change in state of power usage/requirements of one of the devices in the collaborative UE group (e.g., based on pathloss change, and/or location change of one of the devices in the collaborative UE group, among others). The PH reported may be based on a worst-case PH of an entire set or a subset of devices in the collaborative UE group, for example to ensure that a resulting bandwidth reservation does not result in a device (e.g., any device) in the set or subset exceeding a maximum permissible transmission power.

The anchor UE may determine to send and/or may send additional UL information, for example, a CSI report, if configured by the NE/gNB/network. The anchor UE may decide/determine to report CSI, if the associated reported buffer status (for example, determined/established as: (i) a joint BSR for: (a) the entire collaborative UE group, and/or (b) a subset of or all devices in the collaborative UE group and/or (ii) individual devices in the collaborative UE group) is above or below a certain threshold. Such a buffer status may indicate higher volume of data to be sent, which may, for example, benefit from a more accurate and/or updated CSI report.

In certain examples, devices (e.g., in the collaborative UE group) may be configured with an additional UL (e.g., a supplementary UL (SUL)). The SUL may be in addition to the UL (sometime referred to as a normal UL or non-supplemental UL). The devices may be directed to not use the SUL (e.g., use the normal UL instead) or to switch to the SUL under certain scenarios for data transmissions in the UL. For example, if channel conditions experienced by a device are good (e.g., meet a criteria or are above a threshold) and/or bandwidth needs/requirements of the UL data are large (e.g., exceed a criteria or threshold), the non-SUL may be used. If a device in the collaborative UE group, a subset of the devices in the collaborative UE group are power constrained or all devices in the collaborative UE group are: (i) experiencing poor channel conditions, (ii) power constrained, and/or (iii) do not have a high bandwidth requirement (e.g., determined to use less than a bandwidth of a threshold size), the UL transmissions for this collaborative UE group may be controlled by the NE/gNB on the SUL.

In some examples, the UE may prefer to use the SUL over the non-SUL/normal UL for higher data rates since the SUL may be or is generally at lower carrier frequencies.

In certain representative embodiments, the anchor UE may have additional information (e.g., that link degradation has improved for a collaborative UE), and the anchor UE may send an indication to indicate/notify the NE/gNB/network of changed CSI conditions for the collaborative UE.

Representative Procedures for Receiving Information Associated with Coordination/UE Actions

The UE may receive information and/or an indication from the network/other UEs for enabling periodic/dynamic allocations of resources in the collaborative UE group.

In certain representative embodiments, periodic allocations of resources (e.g., a configured grant may be sent in the DL for resource allocations in the UL) and/or any configuration information may be sent to UEs in the collaborative UE group.

In certain representative embodiments, dynamic allocations of resources and/or any configuration information may be sent to UEs in the collaborative UE group.

To enable such embodiments disclosed herein, any of the following may occur. For example, The anchor UE may receive higher/application-layer information about the experience (e.g., the XR experience). The information may be relevant for the anchor UE and/or the collaborative UEs forming part of the XR experience and/or, for example, may be beneficial for the XR action. A collaborative UE may also receive higher/application-layer information about the XR experience. The higher/application-layer information about the XR experience may include, for example, any of the following parameters for or associated with the anchor UE and/or the one or more collaborative UEs: (i) information about traffic, (for example, information such as (a) packet size, (b) expected arrival of PDUs and/or a group/cluster/burst of PDUs, or the like), (ii) expected periodicity of the traffic, (iii) average expected jitter of traffic, etc. (iv) one or multiple thresholds associated with the XR experience/XR application that may require/cause the triggering of a different resource grant allocation/configuration for the anchor UE and/or the one or more collaborative UEs in the collaborative UE group. N Thresholds, Tₙ (where N is a number of UEs in the collaborative UE group n≥1) may be determined by the application on a per-UE basis, in which case the anchor UE may receive one Threshold per UE for the collaborative UE group.

The anchor UE may receive assistance information from the network/NE/gNB, for example to enable/facilitate the XR experience. The assistance information may include any of the following. For example, the assistance information may include configuration information (e.g., in RRC signaling) related to the anchor UE and/or the collaborative UE group and/or a subset or all of the collaborative UEs forming part of the collaborative UE group. The configuration information may be tagged/accompanied by a collaborative UE group ID and/or IDs of individual UEs forming part or all of the collaborative UE group. As another example, the assistance information may include information regarding one or more pre-configured sets of resource grants, (e.g., for each UE in the collaborative UE group including the anchor UE)) out of which one or more may be activated. In certain embodiment, only a single set of resource grants may be activated. The sets of pre-configured resource grants may have been approved/pre-approved by the network (NW)/NE following input from the anchor UE and/or collaborative UEs (e.g., based on the expected traffic, for example for each respective UE in the collaborative UE group). The initial selection of an activated resource grant may be based on the following: (1) the UE receiving a resource grant activated by the NE/gNB in a beginning of the XR session based on knowledge of the type/class of UE and/or the type of traffic (e.g., characteristics of the type of traffic such as traffic volume and/or traffic periodicity, among others), (2) the UE receiving a resource grant activated by the NE/gNB in the beginning of the XR session based on historical knowledge of the resource grants activated in previous time periods for the same type of XR experience, (3) the UE receiving a resource grant activated by gNB in the beginning of the XR session based on one or more indications from the UE (e.g., either the anchor UE or a collaborative UE) regarding traffic information (e.g., the traffic periodicity and/or traffic volume, among others).

In certain representative embodiments, an overall/combined threshold, T, that may trigger a change in the resource grant allocation, for the anchor UE and/or one or more of the collaborative UEs in the collaborative UE group. In various representative embodiments, in addition to or in lieu of an overall threshold T, other thresholds may be configured on a per-UE basis, in which case, the anchor UE may receive one threshold per UE for each UE in the collaborative UE group.

In certain examples, the collaborative UE may receive assistance information from the NW/gNB/NE, for example to enable/facilitate the XR experience. The assistance information may include any of the following. For example, the assistance information may include configuration information (e.g., in RRC signaling) related to itself and/or the collaborative UE group and/or a subset or all of the collaborative UEs forming part of the collaborative UE group. The configuration information may be tagged/accompanied by a collaborative UE group ID and/or IDs of individual UEs forming part or all of the collaborative UE group. As another example, the assistance information may include information regarding one or more pre-configured sets of resource grants, (e.g., for itself) out of which one or more may be activated. In certain embodiment, only a single set of resource grants may be activated. The sets of pre-configured resource grants may have been approved/pre-approved by the network (NW)/NE following input from the anchor UE and/or collaborative UEs (e.g., based on the expected traffic, for example for each respective UE in the collaborative UE group). The initial selection of an activated resource grant may be based on the following: (1) the UE receiving a resource grant activated by the NE/gNB in a beginning of the XR session based on knowledge of the type/class of UE and/or the type of traffic (e.g., characteristics of the type of traffic such as traffic volume and/or traffic periodicity, among others), (2) the UE receiving a resource grant activated by the NE/gNB in the beginning of the XR session based on historical knowledge of the resource grants activated in previous time periods for the same type of XR experience, (3) the UE receiving a resource grant activated by the NE/gNB in the beginning of the XR session based on one or more indications from the UE (either the anchor UE or the collaborative UE) regarding traffic information (e.g., the traffic periodicity and/or traffic volume, among others).

In an embodiment, the collaborative UE may receive a threshold from the NW that may trigger the collaborative UE to request for a change in a resource grant configuration for the collaborative UE.

The anchor UE may receive an indication of an event from the application and event information (e.g., more details about the event (e.g., such as a duration of event, a priority associated with the event, a start time of the event, and/or an event type, among others)). The event, for example, may result in a change in the current mode of operation (e.g., a change in a resource grant allocation, a change in periodicity of the configured grant, and/or an application of an offset to the resource grant allocation, among others). Examples of various events are disclosed herein including with regard the collaborative XR portions.

The anchor UE may receive a resource grant activation for the anchor UE from the NE/gNB/BS, e.g., following a request to the NE/gNB/BS to change a resource allocation configuration for the anchor UE. A change in a resource allocation configuration may either mean/cause a selection of a different resource allocation configuration or an application of an offset to an ongoing one (e.g., an offset to an existing, active set of resource allocations).

The anchor UE may receive a resource grant confirmation for the one or more UEs in the collaborative UE group, at a start of an XR session and/or throughout the XR session and/or following any change in the resource grant configuration of any UEs in the collaborative UE group.

The anchor UE may receive a message and/or an indication from the NE/gNB/NW that its request for a change in resource grant allocation for the anchor UE and/or the one or more collaborative UEs in the collaborative UE group is not granted (e.g., is rejected) or may not be granted. The message may be accompanied by information indicating one or more alternative scheduling options, for example: (i) a change in resource grant allocations for the anchor UE and/or the one or more collaborative UEs may not be granted for the next/upcoming cycle, but may be granted in a few cycles in the future; (ii) a change in resource grant allocations for the anchor UE and/or the one or more collaborative UEs may not be granted immediately, but may be granted in a certain time period in the future (e.g., in 30 ms); and/or (iii) a change in resource grant allocations for the anchor UE and/or the one or more collaborative UEs may not be granted, but an alternate set of resource grant allocations for the anchor UE and/or the one or more collaborative UEs may be granted.

In certain representative embodiments, the anchor UE may receive an explicit indication from the NE/gNB/NW to revert to a default/originally activated mode of resource grant allocation for the anchor UE. The NE/gNB may send the explicit indication to the anchor UE based on an observation of normal traffic conditions/requirements (e.g., based on a determination that the traffic conditions/requirements have returned to normal) based on, for example, a restoration of a quality metric (e.g., the QoE), as indicated by the application service (e.g., XR application service).

For example, the collaborative UE may receive an explicit indication from the NE/gNB/NW to revert to its default/originally activated mode of resource grant allocation. The NE/gNB/NW may send the explicit indication to the collaborative UE based on an observation of normal traffic conditions/requirements (e.g., based on a determination that the traffic conditions/requirements have returned to normal) based on, for example, a restoration of a quality metric (e.g., the QoE), as indicated by the application service.

The collaborative UE may receive an indication/message from the anchor UE in the collaborative UE group to indicate when to listen/monitor for a DL transmission via the DL control channel (e.g., the PDCCH transmission), on condition that the anchor UE has requested a change and/or offset to the resource grant allocations for the collaborative UE. The indication may contain or include more granular information to find/locate/listen/monitor for the upcoming transmissions (e.g., the message/indication from the anchor UE may include information indicating a specific frequency range, bandwidth part and/or search space set, among others). In certain representative embodiments, the message received by the collaborative UE from the anchor UE may include an indication that the NE/gNB/NW may send a low-power signal (e.g., WUS) with information (e.g., all the required information) for the one or more collaborative UEs (for example to act collaboratively) and may indicate a window in which to expect the low-power signal from the NE/gNB/NW.

The collaborative UE may receive data from the application. A time-of-arrival of data at the collaborative UE may be measured by the collaborative UE and arrival outside of an expected time window may trigger an event, which may lead to a request to alter/change a resource allocation configuration.

The UE may receive dynamic resources from the NE/gNB/NW based on the dynamic signaling provided by the anchor UE and the collaborative UE group (e.g., devices associated with the collaborative UE group). Each device/UE in the group may be individually allocated UL grants for UL data transmission. The NE/gNB may use a unique device identifier (e.g., a C-RNTI, and/or a UE ID, among others) to differentiate between the UEs/devices. For example, the NE/gNB may have direct control over what resources are being allocated to the collaborative UE in the collaborative UE group, for example, which may be beneficial in situations where certain applications have a low latency requirement. In such a case, the UE may prefer to receive a direct indication of resources from the NE/gNB as opposed to piggybacking its way via the anchor UE. This may have the additional benefit of reducing signaling and processing requirements at the anchor UE.

The collaborative UE may receive information regarding which set of time and/or frequency resources the UE may use to transmit. The UE may receive the time domain resource information via DCI, for example. The collaborative UE may also be provided with information indicating a delay. The delay may indicate a synchronization delay between or among the collaborative UEs measured from the PUSCH slot and length of consecutive symbols allocated for the PUSCH to the collaborative UE by the resource grant via the DCI. Each UE may be provided an offset in time and/or frequency resources, for example to reduce or substantially eliminate the delay. The offset may be indicated in the DCI or provided by the anchor UE.

The issued UL grants may have an associated timer (time value) which may ensure that the grant received by the collaborative UE is active for a certain time duration, for example, based on the timer (e.g., expiry of a period based on the time value). The network may infer the timing based on BSRs received from the UEs in the collaborative UE group. The inferred timing procedure may be beneficial in scenarios in which the BSR may indicate a sudden surge in UL data needs, but with an associated variability (for example, in jitter), that may imply a need for UL resources that may be usable within a certain time window (for example, a time window of T, where the parameters associated with T may include a start time slot, end time slot and duration/length of T, where the duration/length of T may be measured in number of time slots, symbol duration, SFN and/or seconds/milliseconds).

The time for which a certain grant is active may depend on some relative time difference or offset based on all or a subset of UEs in the collaborative UE group. This may be relevant in a scenario where there is some correlation between or among UEs based on the XR application flow being served, which may result in a serial UL data transmission for the group of UEs. For the example described previously, in the scenario where one UE receives a grant that is valid for a time window of T₁, other UEs in the collaborative UE group may have grants issued that are valid for a time window T₂, where T₂ may be equal to T₁ in length/duration, and T₂ may have an offset value with respect to the start time slot of T₁; and T₁, T₂ and the offset value may be expressed in terms of number of time slots, symbol duration, SFN and/or seconds/milliseconds, and so on. The gNB may use the DCI to provide information indicating a delay (e.g., a PUSCH slot delay and/or a number of consecutive symbols allocated for each PUSCH) to accommodate/account for time validity and/or offset durations of the grants, as described above. Correspondingly, the UE may receive the indications from the NE/gNB (e.g., via the DCI).

The NE/gNB may pre-emptively allocate more resources than requested by the set of anchor/collaborative UEs in the collaborative UE group. This may occur, for example, if the NE/gNB anticipates a future use/need for UL resources based on a network-side buffer status for DL and/or information from the application server (e.g., the XR application server). In certain examples, the NE/gNB may infer that a sudden burst in the DL traffic volume may provide a need/use for additional resources for UL resources, based on some level of DL/UL application-level symmetry. The NE/gNB may indicate the priority level (for example, the LCG), of the additional resources (e.g., the additional resources being allocated to a LCG having an associated priority level). The additional resources may be indicated in the issued UL grant for one or more relevant devices that may need/use those resources. The anchor UE may receive an indication of extra resources than requested by the anchor UE and/or the one or more collaborative UEs in the collaborative UE group, which the anchor UE may use when planning for future resource requirements.

In certain representative embodiments, the anchor UE may be the UE (e.g., the only UE) in the collaborative UE group which may receive an UL grant. For example, the anchor UE may receive from the NE/gNB information indicating the anchor UE is the only UE in the collaborative UE group to receive an UL grant.

In certain representative embodiments, the anchor UE may receive an indication from the NE/gNB that a partial set (e.g., only a partial set) of UL resources are being provided for the anchor UE and/or the one or more collaborative UEs. For example, the UE may receive an explicit indication from the NE/gNB for a specific action to take as a result of the indication that only the partial set of UL resources are being provided. For example, the anchor UE may receive information indicating to prioritize data between some UEs in the collaborative UE group.

The collaborative UE may receive a partial amount/allocation of the UL resources (e.g., only a partial amount of the resources) requested either by itself or by the anchor UE on behalf of the collaborative UE. The partial allocation of the UL grant may be accompanied by an explicit indication by the NE/gNB which may include a reason for the partial allocation and/or a cause code.

In certain representative embodiments, the anchor UE may receive an indication from the NE/gNB on the reason/cause of why only partial resources are being granted in the UL. For example, the NE/gNB may be unable to successfully decode UL transmissions from certain collaborative UEs in the collaborative UE group, for example, due to poor channel quality, and/or blockage, among others, and the NE/gNB may decide/determine to re-allocate resources at a later time, when link quality is improved (e.g., when there may be less link degradation). If the anchor UE has additional information (e.g., that link degradation may no longer be an issue), the anchor UE may send an updated CSI report to the NE/gNB.

The anchor UE may receive information from the application/NW indicating that overlap/redundancy may exist in the data being sent in the UL by one or more collaborative UEs in the collaborative UE group (e.g., which may include the anchor UE). Such redundancy may exist, for example, due to common FoV/extended FOV mapping by multiple glass-type UEs within the collaborative UE group. This may be the case for UEs in different collaborative UE groups.

In certain representative embodiments, the anchor UE may receive information from the network regarding a collaborative UE. For example, if the anchor UE has been handling dynamic indication of buffer status for the collaborative UE or a subset of collaborative UEs within the collaborative UE group, and an event at the collaborative UE triggers the collaborative UE to report buffer status directly to the NE/gNB, the NE/gNB may indicate this to the anchor UE. Such a trigger may occur if, for example, a sudden increase in UL traffic occurs, for example, due to application layer related changes, such as a sudden movement resulting in a change in FoV of the collaborative UE.

### Representative Procedures for Enabling Coordinated Transmissions/Receptions at UEs in a Collaborative UE Group

The UEs may perform actions and/or behaviors associated with coordinated transmissions and/or reception in the collaborative UE group based on any one or more of the following: (1) threshold values, (2) configurations, (3) triggering events/conditions that may come from any of: (i) the application, (ii) the AS layer, (iii) conditions/criteria/messages received from the network (e.g., a configuration message that the UE may receive from RRC signaling) and/or (iv) hosted application (e.g., application functions hosted by the UE).

The anchor UE may select a resource grant configuration for the anchor UE and one or more collaborative UEs in the collaborative UE group, out of a set of pre-activated resource grants for the anchor UE and for the one or more collaborative UEs in the collaborative UE group, based on any of the parameters described above.

In certain representative embodiments, the anchor UE may send an indication to the NE/gNB to change the resource grant configuration, for example, on condition that: (1) the NW/NE selected a resource grant configuration for the anchor UE and/or one or more collaborative UEs which the anchor UE determines is not an appropriate (e.g., the most appropriate) resource grant configuration for itself and/or the one or more collaborative UEs, and/or (2) the selected and/or currently activated resource grant configuration is no longer the appropriate (e.g., the most appropriate) resource grant configuration for the anchor UE and/or one or more collaborative UEs in collaborative UE group. The procedure may include any of the following: (1) the anchor UE selecting a different resource grant configuration from a pre-configured set of resources for the anchor UE and/or the one or more collaborative UEs; (2) the anchor UE requesting the gNB to alter/modify/tweak/cancel the active resource grant configuration for the anchor UE and/or the one or more collaborative UEs (e.g., using a different periodicity, a different duration of time, and/or a different volume of traffic, among others); (3) the anchor UE requesting the gNB to apply an offset (e.g., in time, in frequency in slots, in symbols, and/or in subcarriers, among others) to the active or upcoming resource grant configuration for the anchor UE and/or the one or more collaborative UEs; and/or (4) the anchor UE requesting an addition of a resource grant configuration which was not part of the initially pre-configured set of resource grant configurations for the anchor UE and/or the one or more collaborative UEs in collaborative UE group.

In certain representative embodiments, the anchor UE may send to the collaborative UE (e.g., via direct and/or SL communications) information indicating an adjustment of resource grant allocations (e.g., on the condition that the anchor UE may have selected an alternate resource configuration for the collaborative UE and/or altered the active resource configuration for the collaborative UE, e.g., by applying an offset).

The anchor UE may send information indicating to the collaborative UE (e.g., any collaborative UE) in the collaborative UE group, when to monitor (e.g., listen to) the DL control channel (e.g., the PDCCH transmission), for example, on the condition that the anchor UE has requested a change and/or an offset to the resource grant allocations for the collaborative UE. The information may also include and/or indicate more granular information to find, locate, listen to and/or monitor for upcoming transmissions (e.g., the anchor UE may indicate a specific frequency range, bandwidth part and/or search space set, among others). The anchor UE may indicate and/or send a message to the collaborative UE that the NE/gNB may send a low-power signal (e.g., WUS) with the information (e.g., all the information) used or required for the one or more collaborative UEs and may indicate a window in which to expect the low-power signal from the NE/gNB.

In certain representative embodiments, the anchor UE may be configured to send periodic indications to the one or more collaborative UEs regarding the status of the resource grant allocations for anchor UE and/or the one or more collaborative UEs in the collaborative UE group.

In certain representative embodiments, the collaborative UE may send dynamic and/or periodic indications to the anchor UE (e.g., via direct/SL communications) to request a change in the resource grant configuration of the anchor UE. For example, the indications may be: (1) a request to review the active resource grant allocation (e.g., active configured grant configuration, e.g., including the periodicity and/or the bitrate, among others) and/or (2) a request to switch to a different resource grant configuration which may have been pre-approved by the NW/NE.

For example, the anchor UE may implement a timer and/or counter (e.g., a timing or counting operation) which gets activated every cycle in a periodic-type resource configuration (e.g., at the activation/start of a new configured grant cycle and/or at the time of sending the first UL grant). The duration of the timer (e.g., a time period associated with a time value) may match the length of the cycle. At the expiry of the timer and/or time period, the anchor UE may send a status message to the one or more collaborative UEs as part of the collaborative UE group to indicate the resource grant allocations of one, a subset or all of the UEs in the collaborative UE group.

In certain representative embodiments, the collaborative UE may implement a timer and/or counter (e.g., a timing or counting operation) to determine/know when to wake up. The timer, counter, or time period may start at the beginning of every resource grant allocation (e.g., the start of the first configured grant allocation) and may expire either at every period or at one or more integer multiples of the period. In an illustrative exemplary scenario (see FIG. 3), the timer, the counter or the time period may start at t_{A} and may expire at t_{B} or t_{C}. It is noted that t_{A}, t_{B}, and t_{C} may be in ms. At expiry of the timer, counter or time period), the collaborative UE may monitor the DL control channel (e.g., the PDCCH transmission) to determine and/or learn about any change in the resource allocation configuration of the collaborative UE (e.g., on the condition that the anchor UE has sent a request to change from, e.g., configured grant 1 to configured grant 2), for example as a result of an event detected by the anchor UE in the aim of aligning/synchronizing transmissions between the anchor UE and the collaborative UE. If the collaborative UE wakes up, for example from sleeping, from DL transmissions from the NE/gNB before the expiry of the timer/counter/time period, the collaborative UE may start monitoring for messages/indications from the NW/NE/gNB on the DL control channel, before the expiry of the timer/counter/time period.

The collaborative UE may be configured to wake up periodically (e.g., with statically or semi-statically defined periodicity) to receive an update on the current (e.g., most refresh/recent) resource grant allocation of the one or more collaborative UEs in the collaborative UE group. The periodicity may be configured by the NE/gNB or by the anchor UE and may be approved by the NE/gNB.

As an example, the anchor UE may receive an explicit indication from the NE/gNB to revert to a default/previously activated mode of the resource grant allocation (e.g., a first activated configured grant). The NE/gNB may send the explicit indication to the anchor UE based on, for example, observing and/or determining that the traffic conditions/requirements have returned to normal based on, for example: (1) a restoration of the quality metric (e.g., the QoE), for example, as indicated by the XR application service and/or (2) a restoration of the link quality following a previous degradation, among others.

As another example, the collaborative UE may receive an explicit indication from the NE/gNB to revert to its default/previously activated mode of the resource grant allocation (e.g., a first activated configured grant). The NE/gNB may send the explicit indication to the collaborative UE based on, for example, observing and/or determining that the traffic conditions/requirements have returned to normal based on, for example: (1) a restoration of the quality metric (e.g., the QoE), for example, as indicated by the XR application service and/or (2) a restoration of the link quality following a previous degradation, among others.

One the condition that the collaborative UE detects a clash/mismatch between the resource grant allocation selected by the anchor UE and the one selected by the NE/gNB (e.g., through separate indications sent to the collaborative UE from the anchor UE and the NE/gNB, respectively), the collaborative UE may determine and/or decide to follow the indications from the NE/gNB or, for example to wake up at both times (e.g., at a time corresponding to a first UL grant indicated by the NE/gNB and a second time of the first UL grant indicated by the anchor UE). The collaborative UE may also determine to use one or both of the UL grants to send one or more transmissions. In certain embodiments, the collaborative UE may send a message to one or more of the anchor UE or the NE/gNB indicating the mismatch.

A collaborative UE may indicate to change (e.g., a need to change) aspects of how SR/BSR indications are reported on behalf of the collaborative UE by the anchor UE. The collaborative UE may determine, based on some events/conditions, that resource grants and/or resource grant requests coming through the anchor UE may take too long. The collaborative UE may determine to send the BSRs directly to the NE/gNB in this scenario, and send an indication to the anchor UE at the same time for the anchor UE to the take this into consideration when making future SR/BSR requests on behalf of the collaborative UE group. The collaborative UE may be aware of sudden burst of UL traffic due to some trigger at the application layer. The burst may be a short one-time burst that may be inconsistent (non-deterministic) or alternatively, the burst may be somewhat deterministic and/or periodic in nature. The collaborative UE may send a BSR request directly to the NE/gNB and/or indicate a need to send a BSR directly to the network, as opposed to having the anchor UE handle the BSR, for example to ensure timely adaptation to the collaborative UE's resource needs and timely delivery of UL grant information to the collaborative UE.

In certain representative embodiments, the collaborative UE may determine that resources that may be time-limited are reaching the collaborative UE at a later than desirable time and the collaborative UE may decide and/or determine to send BSR requests directly to the NE/gNB.

For example, a change in UL data characteristics (for example, priorities, volume of data, and/or the active number of LCGs), and/or an observed/determined increase in buffer volume at the collaborative UE, may trigger the collaborative UE to perform direct BSR transmission to the NE/gNB. The BSR messages may be subject to some limitations, for example, if the anchor UE has just sent a BSR message for the collaborative UE group, the collaborative UE may wait (e.g., may need to wait) until the collaborative UE receives an UL grant from anchor UE or directly from the NE/gNB. A time period or timer (e.g., retxBSR-Timer) may be used to facilitate or determine how long this collaborative UE may need to wait before the collaborative UE may send a direct BSR to the NE/gNB. For example, the collaborative UE may be able to (e.g., may only be able to) send a direct BSR or modify the BSR reported by the anchor UE on behalf of the collaborative UE at the expiration of the retxBSR-Timer/time period and may be used in conjunction with, for example, a periodicBSR-Timer/a second time period associated with a periodic BSR, which may be configured to ensure that the collaborative UE may provide more frequent or less frequent updated BSRs based on, for example, (1) traffic needs of the collaborative UEs, (2) a change in number of LCGs, and/or (3) priority levels of traffic being served, among others.

A change in the collaborative UEs dynamic indication behavior may be temporary, for example, based on some sort of timer/time period/expiry of a timing operation. For example, the timer/time period may be based on: (1) an estimate of how long an average fluctuation in traffic may last (based on a type of the traffic and/or a historical average) and/or (2) application layer information that is available to the UE.

The collaborative UE may receive an explicit indication from the NE/gNB to revert to a fallback and/or default mode of the dynamic indication (for example, that may be anchor UE based). The NE/gNB may provide this indication, if the collaborative UE determines/observes that the traffic requirements have returned to normal based on a restoration of the quality metric (e.g., the QoE), as indicated by the application service (e.g., XR application service).

A request for a change for how the anchor UE handles the dynamic indication and/or resource reservation behavior of the collaborative UE may be taken as an implicit indication that the collaborative UE is going to now handle BSRs (e.g., all BSR) for itself and that the anchor UE is to account for the handling of the BSRs by the collaborative UE, when providing future BSRs for the collaborative UE group.

In certain representative embodiments, the anchor UE may receive information from the network/NE/gNB regarding a collaborative UE. For example, if the anchor UE has been handling the dynamic indication of buffer status for the collaborative UE or a subset of collaborative UEs within the collaborative UE group, and an event/condition at the collaborative UE triggers the collaborative UE to report buffer status directly to the NE/gNB, the NE/gNB may indicate the directly reported BSR to the anchor UE. For instance, such a trigger may occur if a sudden increase in UL traffic occurs, for example, due to application layer related changes (e.g., a sudden movement resulting in a change in FoV of the collaborative UE).

The anchor UE may use the indication of the directly reported BSR to account for the collaborative UEs that are now directly reporting BSR to the NE/gNB and exclude such collaborative UEs from the next BSR of the anchor UE to report for the collaborative UE group. Once triggered, the duration for which the one or more collaborative UEs may report individual BSR may be determined by a timing operation/time value/timer, upon expiration of which the one or more collaborative UEs may fall back to relying on the anchor UE to report their buffer status.

In certain examples, a collaborative UE may dynamically indicate BSRs directly to the NE/gNB, on condition that a change in associated LCGs occurs for the UL traffic. For example, a collaborative UE may notice and/or determine that a drop in the number of LCGs occurred, which in turn may indicate a change in priorities of traffic needing service and may occur if the UE notices/determines that there is one primary LCG (e.g., for audio), which may benefit from a configured grant based scheduling option. The UE may benefit from providing a direct BSR to the NE/gNB, such that the NE/gNB may estimate (e.g., best estimate) the RRC configuration (e.g., the required RRC configuration, for example, the periodicity of a configured grant). The NE/gNB may prioritize and/or facilitate anchor UE based joint BSRs vs. UE specific BSRs for the collaborative UE group. The NE/gNB may choose to prioritize BSRs provided by the anchor UE, when allocating UL grants for the UEs in the collaborative UE group, but then may revert back to individual BSR reports, if the NE/gNB determines/detects a discrepancy between buffer status information/values.

For example, if the NE/gNB determines, detects and/or observes that a sudden and/or consistent difference exists (based on some time average, and/or threshold, among others) between joint BSR resource measures versus a total of all individual BSRs across the collaborative UE group, the NE/gNB may choose to use the individual BSRs, when determining appropriate resource allocations. The NE/gNB may revert to using the joint BSR, if this difference falls back to below a threshold. In some embodiments, the switch may depend on some timer/time period/timing operation.

Representative Procedures, for Example, for a UE to Receive Information on Allowable Changes that the UE May Perform without Notifying the NW

According to certain representative embodiments, a UE may receive information on “allowable changes” that it may make and/or activate without indication to a gNB/NW. In one embodiment, the UE (e.g., anchor UE) may be configured to receive, from the gNB/NW, configuration information on “allowable changes” that it may be able to perform and/or activate without notifying the gNB/NW and/or other changes beyond the allowable changes that it may need to indicate to the gNB/NW.

For example, the UE may be configured to receive one or more time thresholds T1, T2, . . . . Tn such that, in the event that there may be a delay δ in the UE receiving the data from the XR application (e.g., as a result of jitter), the UE may be configured to perform the following. In an embodiment, if δ<T1, the UE (e.g., anchor) may be configured to transmit the UL data using CG resources with default parameters (i.e., the CG config activated by default).

According to an embodiment, if T1<δ<T2, the UE (e.g., anchor) may be configured to transmit the data in UL using time shifted CG resources. Such a change may correspond to a configured “allowable change” whereby the UE may not need to inform the gNB/NW about the change prior to implementing and/or activating it and/or following activation or implementation. An allowable change may, for example, include shifting the default CG configuration by a few slots (e.g., 1, 2, 3, 4, . . . , K) where K may be considered to be a small enough number that the UE (e.g., anchor) may not need to inform the gNB. In another example, one or more UEs in a UE group (e.g., anchor UE or member UE) may each be configured with multiple CG configurations such that switching from one CG configuration to another CG configuration for either the anchor UE or the member UE may be considered an “allowable change” by the gNB/NW such that the UE (e.g., anchor) may not need to inform the gNB/NW about the switch. In this example, the UE (e.g., anchor) may trigger a change in the activated CG config for the member UE as a result of the delay δ.

In an embodiment, if δ>T2, the UE may be configured to transmit an indication to gNB/NW to request for new and/or updated resources for anchor UE and member UE. Indications may correspond to any one or more of the following: change in the activated CG configuration of the anchor UE and/or member UE (e.g., change from one CG configuration to another CG configuration), time shift and/or shift by a certain number of occasions and/or slots in the CG configuration of the anchor UE and/or member UE (e.g., In this case, the time shift and/or number of occasions/slots to shift may be larger than K such that the change may not be considered an “allowable change” and the UE may be required to inform the gNB), request to activate more than one CG configuration for the anchor UE and/or member UE, and/or request for additional uplink grant (e.g., dynamic grant) from the network. UE (e.g., anchor) may send a request to the network to request for uplink resources for itself and/or member UE(s).

According to an embodiment, for example, the thresholds that the UE may receive from the gNB/NW may correspond to data volume thresholds such that the UE may determine the total volume of the data to be sent in the UL (i.e., payload) and may assess it against the data volume threshold. In one example, the UE may receive one or more data volume thresholds from the gNB/NW, e.g., V1, V2, . . . , Vn etc. such that in the event that there may be a change Q in the UL payload to be sent to the gNB/NW, the UE may be configured to assess the change in payload volume against the data volume thresholds and perform corresponding actions. In one example, if Ω<V1, the UEs (e.g., anchor UE and member UE(s)) may transmit the UL data using CG resources with default parameters (i.e., the CG config activated by default). In another example, if Ω>V1, the UE (e.g., anchor) may send to the gNB/NW request for additional resources for itself and/or the member UE(s).

In an example embodiment, there may be more than one CG activated for any of the anchor UE or member UE(s) at any given time. In one example embodiment, the one or more CG may be specific to individual member UE(s). In another example embodiment, the one or more CG may be on a per UE-group basis. The anchor UE may allocate the resources within the group CG among itself and the member UE(s) based on awareness of XR traffic. In an example embodiment, there may be associations between two or more CG configurations among members in the UE group. In an example, activation of a CG configuration for an anchor UE may automatically and/or by default activate a corresponding CG configuration for a member UE. In one example, the association between two or more CG configurations may be 1:1; in another example, the association may be Many:1 and/or 1:Many.

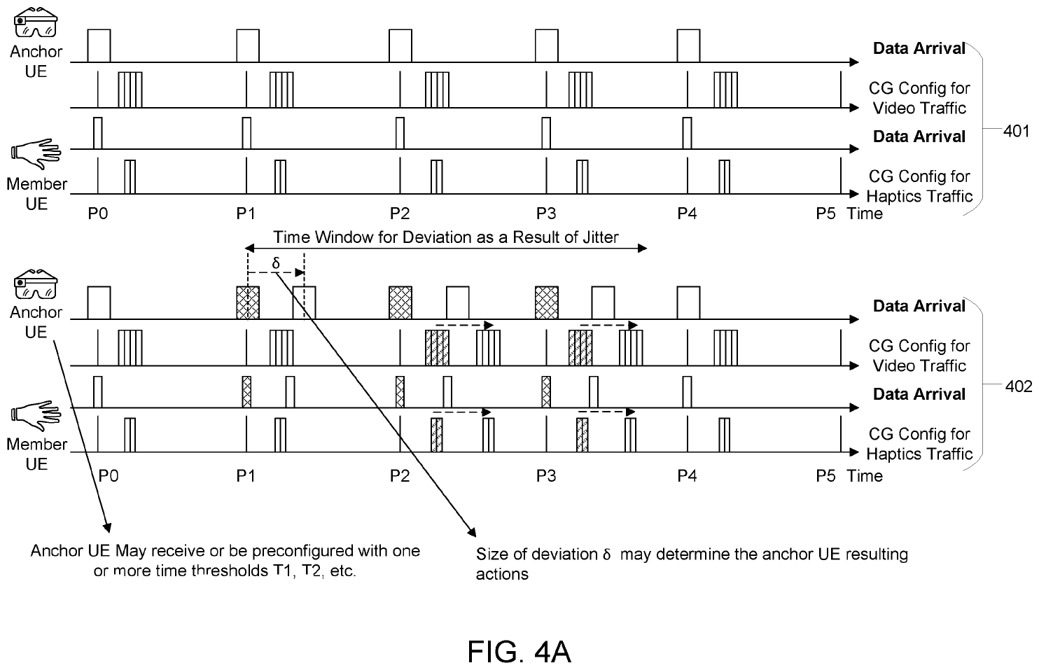

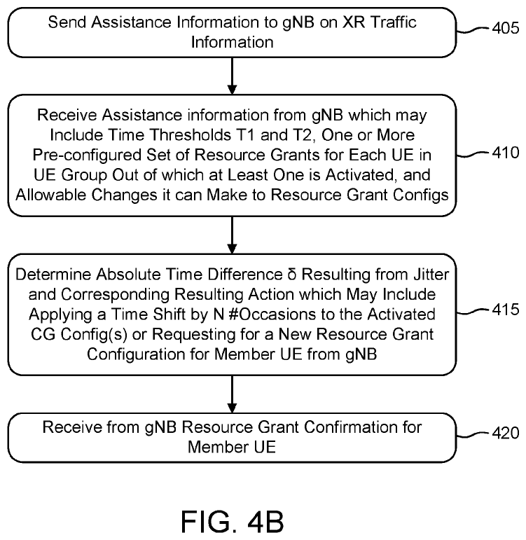

FIGS. 4A and 4B are diagrams illustrating an example of coordinated transmission in a collaborative UE group including an anchor UE and a collaborative UE, according to an embodiment. More specifically, FIG. 4A illustrates an example diagram of a timeline 401 depicting receipt of data and CG configuration at the anchor UE and receipt of data and CG configuration at the collaborative UE, which does not include or account for deviation as a result of jitter. FIG. 4A further depicts an example diagram of a timeline 402 depicting receipt of data and CG configuration at the anchor UE and receipt of data and CG configuration at the collaborative UE, while accounting for deviation as a result of jitter, according to certain embodiments. For example, as illustrated at 402, the anchor UE may be preconfigured with or may receive configuration information that includes one or more time threshold(s) T1, T2, etc. In an embodiment, if the time threshold(s) are exceeded due to jitter, a change in resource grant configuration for the anchor UE and/or member UE(s) may be requested and/or required. According to an example, the size of the deviation, δ, may determine the anchor UE's resulting actions. For instance, if T1<δ<T2, the anchor UE may determine a time shift, for example, by a few seconds/milliseconds and/or number of occasions to apply to the transmit data using default parameters (e.g., CG parameters). However, in an embodiment, if δ>T2, the anchor UE may request for a new resource grant configuration from the network or gNB.

Although not explicitly illustrated in the example of FIG. 4A, in a further embodiment, the anchor UE may be preconfigured with or may receive configuration information that includes one or more data volume threshold(s) V1, V2, etc. In this embodiment, if the data volume threshold(s) are exceeded due to the total amount of data to be sent, a change in resource grant configuration for the anchor UE and/or member UE(s) may be requested and/or required. For example, the anchor UE may receive one or more data volume thresholds (e.g., e.g., V1, V2, . . . , Vn, etc.) from the gNB/NW, such that in the event that there may be a change, Ω, in the UL payload to be sent to the gNB/NW, the anchor UE may be configured to assess the change in payload volume against the data volume thresholds and perform corresponding actions. In one example, if Ω<V1, the UEs (e.g., anchor UE and member UE(s)) may be configured to transmit the UL data using CG resources with default parameters (i.e., the CG configuration activated by default). In another example, if Ω>V1, the anchor UE may send, to the gNB/NW, a request for additional or different CG resources (e.g., larger grant and/or new offset) for itself and/or the member UE(s).

FIG. 4B illustrates an example flow diagram of a method that may be performed by the anchor UE depicted in FIG. 4A or any other anchor UE discussed herein, for example. As illustrated in the example of FIG. 4B, at 405, an anchor UE may send assistance information to a gNB, for example, on XR traffic information. In an embodiment, at 410, the anchor UE may receive assistance information from the gNB. According to certain embodiments, the assistance information may include time thresholds T1 and T2, one or more pre-configured sets of resource grants for each UE in the UE group out of which at least one is activated, and/or allowable changes that the anchor UE can make to resource grant configurations. As such, in this example, the anchor UE may be pre-configured with one or more time thresholds (e.g., T1, T2, etc.) such that, if exceeded due to jitter, a change in resource grant configuration for itself and member UE(s) may be desired or required.

As further illustrated in the example of FIG. 4B, at 415, the anchor UE may determine an absolute time difference (δ) resulting from jitter and corresponding resulting action, which may include applying a time shift by N occasions to the activated CG configuration(s) and/or requesting for a new resource grant configuration for a member UE from the gNB. Thus, in some embodiments, the size of the deviation δ may determine the anchor UE's resulting actions. For example, if the deviation δ is greater than T1 but less that T2, then the UE may determine time shift δ occasions to apply to transmit data using default parameters. As another example, if the deviation δ is greater than T2, then the UE may request new resource configuration. In an embodiment, at 420, the anchor UE may receive, from the gNB, resource grant configuration for the member UE.

Representative Procedures for a UE to Determine Information and/or an Indication to be Sent in the UL Based on an Indication Received in the DL

In certain representative embodiments, the UE may determine what to send in the UL based on what is received in the DL. The following describes such UE actions/behaviors:

The behavior of the anchor UE in the UL may change with detected/observed DL signaling and/or traffic, for example that is received from the NE/gNB. In certain examples, the NE/gNB may switch modes of DL transmission from dynamic grant based to DL semi-persistent scheduling (SPS) based. The mode switch may be triggered by an explicit indication and/or an implicit indication but may not be limited to just these. As an example, an explicit indication may be signaled via a DL channel transmission (e.g., via the PDCCH transmission), whereas an implicit indication may be indicated by a trigger, such as reception of the DL channel transmission (e.g., the PDCCH transmission) with a BWP indicator (e.g., in a switch from an active BWP to a default BWP or to a smaller BWP) and/or by expiration of a timer/time period. The switch from dynamic grant based to SPS based scheduling may be used by the anchor UE as an indication, for example, to modify the dynamic indication in the UL.

Activation of the SPS in the DL may be an indication of higher priority DL traffic, which, in turn, may require a guaranteed symmetric high QoS in the UL direction. This may be associated with a need to change how the anchor UE reports certain dynamic information in the UL (e.g., a change from a joint BSR to individual BSRs for better redundancy).

The anchor UE may adapt the UL data based on detected/observed/determined variations in DL traffic. For example, if the anchor UE detects/observes a sudden higher frequency of DL transmissions, the anchor UE may infer that this change is the result of inadequate or incomplete UL information being transmitted from some subset of devices in the collaborative UE group. The anchor UE may then pre-emptively attempt to compensate for this effect by providing more frequent UL data updates, such as more frequent pose and orientation information and/or more frequent and/or more redundant FoV updates for the spatial and temporal set (e.g., the most recent spatial and temporal set) of FoVs. For example, the anchor UE may infer that a change in volume of the DL traffic, may result in a corresponding needed change in the UL transmissions. The anchor UE may then pre-emptively attempt to request for additional resources prior to needing them. The anchor UE may estimate the additional resources, for example, by calculating how much data it has in the RLC and the PDCP and may scale this amount by some additional factor. In certain representative embodiments, the anchor UE may use a historical average and/or a maximum value based on recent BSR reports, which may be triggered by either burstiness of the DL traffic (e.g., volume) and/or by duration of this burst in the DL. In certain representative embodiments, the request for additional resources may be triggered based on one or more notifications/messages from within the collaborative UE group, for example, if another collaborative UE in the collaborative UE group receives data from the application layer.

In certain representative embodiments, the anchor UE may modify how the anchor UE dynamically requests for resources on behalf of the collaborative UE group based on certain DL signaling. For example, if an anchor UE determines/notes that the dynamic grants issued by the NE/gNB are frequently or regularly underestimating the resources (e.g., necessary resources) assigned for the collaborative UE group, the anchor UE may determine/decide that BSR reports for certain devices are inaccurate (for example, due to a degradation in link quality and/or a blockage, among others), and may determine that the anchor UE may take over (e.g., solely take over) BSR reporting duties for the collaborative UE group.

A collaborative UE may choose to take certain actions based on DL behavior. For example, the collaborative UE may choose to provide a CSI report, if so configured, for example, if the device receives a DL grant either from the anchor UE or directly from the NE/gNB. In certain representative embodiments, if the collaborative UE has not received DL data (e.g., any DL data) for a certain time duration (e.g., which may be based on some threshold), the device may decide/determine to provide a CSI report, for example such that the NE/gNB has accurate CSI information for the device.

In certain representative embodiments, certain characteristics of the buffer status of the one or more UEs in the collaborative UE group may result in a CSI report being provided to the NE/gNB and/or the anchor UE, which, for example may be based on: (1) a size of buffered data (e.g., a size of the buffer status for example may use an absolute size, a time average size, a peak size, and/or a size relation to some threshold value, among others) and/or (2) relative priorities of UL data (for example, the number of LCGs).

Representative Procedures for a UE to Assist a Network with Scheduling DL Data Transmissions for One or More UEs in a Group

In certain representative embodiments, an anchor UE may assist the network in performing scheduling of data transmissions in the DL to one or more UEs in a collaborative UE group. The anchor UE may provide such indications or assistance information based on awareness of one or more factors/parameters, including awareness of data transmissions and/or receptions by/for the UEs in the group, QoS information associated with data flows in UL/DL and certain application/higher layer information, for example. The network can use the assistance information for determining when and how to schedule the DL traffic intended for one or more UEs in the collaborative group. For example, the network may use the information/indications for determining whether to send dynamic grants in DCI to the anchor UE (e.g., intended for the anchor UE or collaborative UE) and/or directly to a collaborative UE, and/or whether to configure new SPS, change parameters of preconfigured SPS and/or activate/deactivate any of preconfigured SPS for the UEs.

In the case of split rendering scenarios where one or more UEs in the group may send data in the UL (e.g., pose/control data, video data) and receive data in the DL (e.g., pre-rendered video, haptics data) which may be associated with the UL data, the anchor UE may be aware of the data expected in the DL for one or more UEs based on the data transmitted in the UL, for example. The anchor UE, for example, may be aware of the timing for when the data may be expected in the DL based on the RTT latency requirement associated with the application. The anchor UE may also be aware of the DL traffic information expected to be received by one or more UEs in the group (e.g., in one or more data flows) based on the UL data transmitted by any of the UEs in the group. The information which may be known by the anchor UE on a per-UE and/or per-flow basis may include a combination of any one or more of the following: data types (e.g., I-frame or P/B-frame, haptics data, video data, etc.), priority/importance and/or relative priority/importance of data types (e.g., I-frame v/s P-frame), payload sizes of the PDUs (e.g., average, min, max), number of PDUs per ADU/PDU set, number of data flows per-UE, QoS of data (e.g., PDB or PDU set delay bound, PER or PDU error rate), timing information (e.g., offset time slot with respect to a reference time slot, remaining time), and/or Uu link measurements of member UEs (e.g., RSRP measurements of BWP, carriers, resource set configured in member UE).

The information (e.g., assistance info), indications and/or request messages that may be sent by the anchor UE to the network to assist with scheduling data transmissions in the DL, possibly at different granularities (e.g., on a per-UE and/or per-flow basis), may include a combination of any one or more of the following: traffic information expected in the DL, adjustments to resource configurations, data consumption and/or processing delay at anchor UE/collaborative UEs, prioritization information, data forwarding configuration, channel/link measurements, spatial attributes of anchor UE/collaborative UE, power savings configuration information of anchor UE/collaborative UE, and/or indication of fallback to default configurations.

For example, the anchor UE may provide information of the data expected in the DL for one or more UEs. Such traffic information may comprise any of payload sizes, data types, number of PDUs per PDU set, any changes to configured traffic parameters (e.g., periodicity, start offset time slot) and any changes to jitter (e.g., jitter is greater/lower than a threshold or within/outside of a range). Such information may be provided based on data transmitted by anchor UE and/or any of collaborative UEs in UL, for example.

In an example, the anchor UE may provide information on the remaining time or time window (e.g., start/end time slot, duration) for the DL data, comprising one or more PDUs in one or more data flows, expected to be received by the anchor UE and/or collaborative UE. Such information may be determined by anchor UE based on tracking of the RTT time with a timer, estimation of data types (e.g., I-frame or P/B frame) and number of PDUs per PDU set expected in DL in a given time window, etc.

As an example, the anchor UE may send indications/requests for new resource configurations (e.g., SPS configurations, BWP, resource set, beams) and/or to update/reconfigure any of the preconfigured resource configurations. In another example, the anchor UE may send a request to activate/deactivate any of the preconfigured resource configurations used for DL receptions in anchor/collaborative UEs. The anchor UE may send an indication (e.g., via SL) to the collaborative UE to perform reception and/or monitoring of control channel (e.g., PDCCH) over the resource configuration associated with member UE requested by the anchor UE to the network, for example.

In an example, where the anchor UE may be provided with information on the SPS resources configured for a collaborative UE, the anchor UE may send an indication to the network to change the offset time slot and/or increase/decrease the periodicity associated with the SPS resources for collaborative UE when detecting an increase/decrease of the RTT time (e.g., with respect to an RTT time threshold) for data transmitted and/or received by the collaborative UE and/or anchor UE. Such scenarios may occur in the case when the anchor UE transmits and/or receives data that may be associated or synchronized with the data transmitted and/or received by the collaborative UE, for example.

As an example, the anchor UE may send indications/information to the network on the consumption of the data (e.g., in one or more flows) which may be previously received and/or expected to be received in the DL at one or more UEs in the collaborative group. With regard to consumption of data, the anchor UE may send information on any of the following: rate of data consumption (e.g., data rate at which the received data is sent to higher layers/applications), amount of buffer (e.g., number of PDUs, amount of payload with respect to a threshold value) maintained/available at lower layers (e.g., at LCH) and/or higher layers prior to consumption, expected time for depleting buffer amount, expected amount of data rate to be applied for DL reception for maintaining buffer at existing level/expected level and indication of whether buffer is empty/full (with respect to configured threshold).

In an example, the anchor UE may send indications/information of processing delay at any of the UEs, which may impact the availability of the receivers and/or the time duration for receiving any DL data. Such processing delay at any of the UEs in the collaborative group may be due to: i) processing of previous reception of DL data, ii) processing of data for an upcoming transmission, iii) whether the UEs may be performing any receptions and/or transmissions over SL such that any DL receptions may not be possible for certain time duration, and iv) whether the UE may be performing channel/link measurements and/or processing of measurements such that any DL receptions may not be possible. In some examples, the anchor UE may indicate to the network whether any measurement gap configuration is activated/deactivated in any of the UEs, which may prevent the UEs from performing transmissions and/or receptions on any other channels for the duration of the measurement gap.

As an example, the anchor UE may send indications to the network on the priority value to apply when forwarding any of the DL data to one or more UEs in the collaborative group. The priority values may be indicated for any of the following data granularities: per-PDU, per-ADU/PDU set (e.g., comprising of multiple PDUs), per-data types (e.g., I/P/B frame, haptics data), and one or more data/QoS flows. In an example, the anchor UE may send an indication to prioritize the DL data transmission to the anchor UE associated with a PDU set carrying P-frame data compared to a PDU set carrying I-frame data (e.g., indication may indicate higher priority value for PDU set with P-frame data compared to PDU set with I-frame data). For example, the anchor UE may send the indication on prioritization when indicating any new/updated priority value compared to a default configured priority value associated with the PDU, PDU set, data type, or data flow.

In another example, the anchor UE may send priority information related to whether Uu link or SL is to be used when any of the collaborative UEs may transmit any data/indication to the network. For example, the anchor UE may send the indication on link prioritization to the network to configure a higher priority for sending any data/indication indirectly from a collaborative UE to anchor via SL compared to the priority value for sending data/indications directly via Uu link. The network may configure in the collaborative UE the priority value associated with the link to use and/or allocate resources (e.g., for Uu link or SL) based on the configured priority value, for example.

As an example, the anchor UE may be aware of the one or more preferred data forwarding configuration(s) for the member UE(s) to support any of the XR actions. This includes both CP and/or UP configurations (e.g., radio bearers, logical channels, links, etc.) and may include latency requirements, data rate requirements, reliability requirements and/or absolute/relative priority requirements. In an example, the latency requirements for a member UE may be expressed in terms of PDB associated with IP packets/PDUs. In another example, the latency requirements may be expressed in terms of an Application Delay Budget and/or a Frame Delay Budget associated with frames (e.g., video/media frames). Similarly in the case of reliability, in one example, the reliability requirements for a member UE may be expressed in terms of Packet Error Rate. In another example, it may be expressed in Frame Error Rate or Application Error Rate. In such cases, the anchor UE may inform the network on the forwarding configuration according to the preferences of the relevant member UE(s). The anchor UE may also perform conversions between requirements expressed in different terms according to different member UE preferences in the group when coordinating the downlink transmissions.

As an example, the anchor UE may send information/reports associated with channel/link measurements made by any of the UEs in the collaborative group. The channels measurements sent by the anchor UE may include the measurements performed by any of the UEs in the group on the associated links/beams/channels over the Uu link (e.g., RSRP measurements) and/or SL (e.g., RSRP, Channel Busy Ratio (CBR) measurements), for example.

In an example, where the one or more UEs in the collaborative UE group may be configured with measurement thresholds (e.g., RSRP thresholds), the anchor UE may send an indication when the measurements made by the anchor UE or collaborative UEs (e.g., when measurements of collaborative UE may be sent to the anchor UE via SL) on the associated channels are higher/lower than the measurement threshold.

In another example, the anchor UE may send information/reports on any positioning measurements (e.g., PRS) and/or positioning RS transmissions (e.g., Sounding Reference Signals for positioning (SRSp)) currently performed or expected to be performed by any of the UEs in the group. Such information may be used by the network to determine whether any prioritization may be done when scheduling data in the DL, for example.

As an example, the anchor UE may send indications to the network related to movement/mobility (e.g., speed, direction) and/or spatial attributes (e.g., position, orientation of antenna, direction of UE viewport) of any of the UEs in the collaborative UE group. The anchor UE may send information on the existing or expected changes to the movement and/or spatial attributes of any of the UEs (e.g., time slot when such changes may be expected in a UE). Such information on the movement/spatial attributes may be used by the network for determining how to schedule any of the resources, resources sets or beams that may be used for sending data in the DL to the UEs, for example.

As an example, the anchor UE may provide information related to any changes that may be performed by the anchor UE and/or collaborative UE to any of the configured power saving schemes (e.g., CDRX/DRX configurations, PDCCH monitoring). Such changes may include those that may be performed autonomously and/or temporarily by any of the UEs in the UE group (e.g., the base station may not be aware of the changes), possibly based on data transmitted in the UL and/or expected to be received in the DL, for example. The indication of information on the power saving schemes used by the UEs in the collaborative group may allow the network to schedule any of the DL receptions by the UEs by accounting for the QoS of data (e.g., data rate and/or latency for receiving PDUs/PDU sets) and/or achieving power saving in the UEs.

In an example, when the anchor UE determines to transition from using a power saving configuration (e.g., anchor UE uses a CDRX configuration where anchor UE may receive data only during ON/active duration time slots) to not using any power saving configuration (e.g., anchor UE may receive UP data in all/any time slots) or vice-versa, the anchor UE may send an indication to the network informing it of the transition. Similarly, the anchor UE may send an indication to the network of such transition when receiving an indication from a member UE (e.g., via SL) of such transition and/or detecting such expected transition (e.g., based on indication from a higher layer/application).

In an example, the anchor UE may send indications when the anchor UE and/or any of the collaborative UEs change or expect to change (e.g., in any upcoming time duration/window) one or more of the power saving parameters, including those of CDRX configurations (e.g., ON/active time duration, inactivity timer duration, cycle duration) or PDCCH monitoring behavior (e.g., search space used for monitoring, coreset/BWP used for monitoring).

As an example, the anchor UE may send indications on whether/when any of the UEs in the collaborative group may fallback and/or transition to using default configurations. In an example, one or more collaborative UEs may be configured to monitor for PDCCH in a default search space and an alternative search space. In this case, the default search space may be intended for receiving DCI associated with sparse resources (e.g., for low data rate or low periodicity DL reception) and the alternative search space may be intended for receiving DCI for dense resources (e.g., for high data rate or high periodicity DL reception). The anchor UE, which may be aware that a collaborative UE may switch from an alternative search space to the default search space, possibly due to awareness of change in data expected in DL, may send an indication to the network indicating that the collaborative UE may switch to the default search space. A similar indication may be sent by the anchor UE to indicate that a UE in the group may switch from an alternative CDRX configuration to the default configuration, for example.

The anchor UE may send to the network any of the above indications, assistance information and/or requests via RRC signaling (e.g., RRC Reconfiguration requests, RRC Resume requests), MAC CE or UCI, for example. The anchor UE may send any of the indications or assistance information periodically or based on detection of one or more triggering events/conditions. For example, the triggering events that may be detected by the anchor UE for sending any of the above indications/information may include a combination of one or more of the following: change in data sent in the UL (e.g., data type changes from I-frame to P/B-frame) and/or QoS applied when transmitting data in the UL (e.g., LCH parameters/priority used when sending data in UL changes) from UEs in the group, detection/estimation of data expected in the DL and/or QoS of data expected in the DL in one or more flows for UEs in the group, change in channel/link measurements (e.g., RSRP value of measurements made by a collaborative UE on CSI-RS associated with a configured resource set is above/below a threshold), change in movement/mobility (e.g., increase/decrease in speed or change in direction) or spatial attributes (e.g., change in position, antenna orientation, viewport direction) of one or more UEs in the group, and/or based on timer/periodic (for example, the anchor UE may send an indication when a timer is started, e.g., when detecting an event, and/or expires. The anchor UE may send the indications periodically based on a configured periodicity, possibly using configured CG resources, for example).

In an example, any of the above information, indications and/or requests that may be sent by the anchor UE, may possibly also be sent directly to the network by one or more collaborative UEs. Such direct indications to the network may be transmitted by the collaborative UE possibly upon satisfying one or more triggering conditions detected by the collaborative UE when handling coordination at the collaborative group. For example, the conditions that may be monitored for deciding whether to send direct indication to the network or indirect indication via the anchor UE may include any one or more of the following: comparison of latency (e.g., between direct transmission and indirect transmission, possibly considering whether ongoing resources are available or new resources may be requested), priority/importance of data associated with the indications, priority value configured for direct link (e.g., Uu link) and/or indirect link (e.g., via SL), availability/priority of resources for sending data directly (on Uu link using available CG) or indirectly (via SL using Mode 1/Mode 2), and/or measurements of link conditions (e.g., Uu link conditions and/or SL conditions).

In an example, in any of the scenarios where the anchor UE may send any indication/information to the network that may impact DL data reception at the anchor UE and/or one or more collaborative UEs, the anchor UE may also send a corresponding indication/information to the collaborative UEs (e.g., via SL). Such indications may be sent via unicast, multicast (e.g., to multiple UEs in UE group) or broadcast transmission to one or more UEs in the collaborative UE group, for example. Such indication to the UEs in the group may indicate any changes to be made to the configurations applied for receiving any of the existing or upcoming DL transmissions, for example.

Representative Procedures for a UE to Assist Other Collaborative UEs with DL Data Reception

In one embodiment, the anchor UE may assist one or more collaborative UEs to become aware of upcoming DL scheduling such that data receptions may be performed efficiently. The information and/or indications that may be provided by the anchor UE to one or more collaborative UEs in the group may include any one or more of the following: resource configuration information, reception configuration, data/QOS related information, prioritization information, channel/link measurements, and/or indication to fallback to default configuration.

As an example, the indication may include the timing information (e.g., start/stop offset time slot, time duration/window) on when to perform PDCCH monitoring for DL data reception. The indication from the anchor UE may include the search space to use (e.g., whether to use sparse or dense search space for PDCCH monitoring), for example.

The indication may include the configuration information (e.g., IDs of SPS configurations to use) and/or changes to parameters (e.g., start offset time slot, periodicity) associated with SPS configurations for receiving periodic DL data. Such resource configuration information may be determined by the anchor UE based on the data sent in the UL, for example.

In an example, the indication from the anchor UE may indicate whether to monitor PDCCH for DCI or use a preconfigured SPS for receiving the DL data.

As an example, the indication from the anchor UE may indicate the links, carriers, BWPs, and/or antenna ports to monitor for receiving control signaling or data in DL.

In an example, the indication may include the AS layer (e.g., DRBs, SRBs) and/or NAS layer configurations to use for receiving and/or processing the DL data.

As an example, the indication from the anchor UE may indicate data/QoS related information on the data expected in the DL by the collaborative UE(s). Such information may include, for example, any of the following: data types (e.g., I/P/B-frame data), number of PDUs per PDU set, number of QoS/data flows, and QoS of data (e.g., PDB/PDU set delay bound, PER/PDU set error rate, data rate).

In an example, the anchor UE may assist the member UE in converting from a common data forwarding configuration from the network to the member UE's preferred data forwarding configuration (e.g., reliability requirements may be expressed in Packet Error Rate at the network and in terms of Application Error Rate at the member UE).

In an example, the anchor UE may indicate whether to receive data in a DL transmission or drop reception over any configured resource set/BWP/channel/link (e.g., for a time duration). The collaborative UE may decide to go into sleep mode (e.g., when configured with CDRX), possibly when receiving an indication to drop data reception.

As an example, the indication from the anchor UE may indicate priority values associated with reception of data (e.g., PDU sets, QoS/data flows), resource configurations to apply (e.g., SPS configurations, dynamic grant configurations), configured interfaces to apply (e.g., Uu link, SL) and/or measurement configuration (e.g., RRM/CSI-RS measurements). The collaborative UE may use the prioritization information received from the anchor UE for determining how to prioritize the reception of DL data.

As an example, the indication from the anchor UE may indicate whether to perform measurements of CSI-RS on configured resource sets. Such indication may be sent by the anchor UE based on its own measurements (e.g., RSRP measured on own resource set is above/below a threshold value).

In an example, the anchor UE may send an indication to a collaborative UE indicating to transmit CSI-reports to the network. Such indication may be sent by the anchor UE based on detection of changes to the DL grants received by the anchor UE, possibly by inferring from the change in DL grants a drop in channel quality for the anchor UE and/or collaborative UE, for example.

As an example, the indication from the anchor UE may indicate to fallback to a default configuration, including default resource configuration (e.g., default SPS config), default PDCCH monitoring parameters/behavior (e.g., default/initial BWP).

The anchor UE may send to one or more of the collaborative UEs any of the above indications, information and/or requests via PC5-RRC signaling, SL MAC CE or SCI (e.g., over the SL interface), for example. Such indications may be sent via unicast, multi-cast or broadcast transmissions to one or more UEs via SL. The anchor UE may send any of the indications/information periodically or based on detection of one or more triggering events/conditions, similar to the triggering events described above for sending indications/information to the network, for example.

### Representative Procedures for Using the Sidelink Interface in Coordinated Transmissions/Receptions

In some embodiments, a WTRU may use the sidelink interface to connect with one or more WTRU(s) in the collaborative WTRU group. From a connectivity perspective, leveraging the sidelink interface of one or more WTRU(s) involved in the XR experience for data transmissions can alleviate the load on the Uu link.

Bringing the coordination point locally to the anchor WTRU and using sidelink to communicate with other WTRUs in proximity may also allow for fast and efficient discovery, connectivity, coordination, scheduling, data transmission, and data reception among multiple WTRU(s) forming part of one common XR application/service/experience, possibly located around the anchor WTRU (e.g., within a set radius/perimeter measured in meters).

Coordination, described herein, may include any procedures, functionalities and operations at one or more layers (e.g., access stratum/RAN layers, NAS layers, application layers) involving one or more WTRUs that may be associated with a common application/service (e.g. XR application). For example, the procedures and/or functionalities that may be performed collaboratively among WTRUs (possibly coordinated by the anchor WTRU) may include discovery, WTRU selection, configuration, resource scheduling, power savings, link management (both SL and respective Uu link interfaces), etc. The sidelink interface may facilitate coordination to be supported dynamically between WTRUs in the WTRU group to ensure continuity of the immersive experience of the user, based on locally available information, such as pose and (extended) FoV.

In example embodiments, coordinated transmissions for collaborative WTRUs over the sidelink interface may involve the use of one or more similar and/or overlapping criteria with that of coordinated transmissions for collaborative WTRUs over the Uu interface. In an example, a WTRU may be able to perform coordinated transmissions among multiple WTRUs when the radio conditions (e.g., RSRP measurements) and load conditions (e.g., CBR measurements) over the SL interfaces and/or SL resource pools are below/above one or more configured threshold values (e.g., SL RSRP threshold, CDRX threshold).

### Use of the Sidelink Interface for Coordinated Transmissions

Once sidelink is established between one or more WTRUs, either through solicitation or discovery, messages/indications/reports related to ‘XR actions’ may be exchanged between an anchor WTRU and a collaborative WTRU, including measurements/estimates related to pose information and/or FoV/extended FoV. Exchanges over the sidelink also may be related to measurements/estimates of the radio link interfaces associated with any WTRU in the collaborative WTRU group (for example, channel/load conditions on the sidelink channel). In an example embodiment, a collaborative WTRU may send an indication when the quality/load of the channel used by the WTRU (e.g., for performing one or more ‘XR actions’) meets certain measurement criteria, such as the RSRP/RSRQ/RRSI measurements of the channel (over the SL interfaces) and/or channel busy ratio (CBR) of the channel over SL interfaces is above/below the respective threshold values and/or remains above/below the respective threshold value for a certain duration.

Exchanges over the sidelink may include connectivity capabilities on the sidelink interface, e.g., the number of carriers, bandwidth, WTRU antenna configuration, number of Tx/Rx antennas, the forwarding configurations that are supported over the sidelink interface, etc. In an example, such exchange may be initiated by the anchor WTRU sending a request to a collaborative WTRU enquiring about the connectivity capabilities on the sidelink interface. In another example, capability exchange over the sidelink may include application layer information such as spatial capability of the WTRU (e.g., equipped with camera, microphone, etc.) for assessing potential participation in one or more ‘XR actions’.

The sidelink interface also may be used to send user plane data and related status reports associated with one or more ‘XR actions’ between two or more WTRUs in the WTRU group. Examples may include the signaling or the start or the completion of an XR action and/or milestone(s) of an XR action.

### Mode 1 and Mode 2 Sidelink Transmissions

Coordinated transmissions via the sidelink interface may take place over mode 1 and/or mode 2. For operating in mode 1, at least one WTRU in the WTRU group is within coverage of a cell/gNB. Radio resources over the sidelink may be allocated from carriers/bandwidth dedicated to communications over the sidelink or from carriers/bandwidth that share resources between SL and Uu link communications. The sidelink radio resources can be configured so that mode 1 and mode 2 may share a resource pool or use separate resource pools. In collaborative WTRU group scenarios, both mode 1 and mode 2 resource allocation approaches may be used for transmitting data and/or control indications/messages between the anchor WTRU and member WTRUs, for example. The transmitting WTRU (e.g. anchor WTRU or member WTRU) may be configured to use mode 1, mode 2 or both simultaneously when performing SL transmissions to the receiving WTRU.

Pool sharing may result in an efficient use of resources, but may be prone to contention and subsequent contention resolution, which, in turn, may introduce additional delays in transmissions. In some cases, introduced delays from contention resolution may be acceptable such that QoS requirements for the XR traffic are still met. In other cases, however, contention resolution may negatively impact the QoS. As such, a WTRU may be configured with both mode 1 and mode 2 sidelink transmissions, irrespective of whether the WTRU may be in network coverage or not, whereby the WTRU may be able to assess which mode may be more suitable (e.g., based on the awareness of traffic from the XR application that is to be transmitted) and send indications to the network (e.g., in UCI) to inform the network of the selected mode of operation so that the network may provision/proportion radio resources accordingly.

The WTRU, when configured with both mode 1 and mode 2, may select mode 1 for the transmission of the more important traffic with higher reliability. In an example, the WTRU may select mode 1 and/or mode 2 transmission based on the QoS marking of the data in its buffer. In another example, the WTRU may receive an indication of importance of the data from its XR application, which may be indicated to the WTRU at different granularity levels (e.g., on a frame basis and/or group of frames basis and/or PDU basis and/or PDU-set basis and/or group of PDU-sets basis, etc.). Based on the indication from the application, the WTRU may assess whether the data is important enough (e.g., with importance levels above preconfigured thresholds sent by gNB and/or QoS marking above a certain rating). If the WTRU deems the data to be important enough to require a more reliable method of transmission, the WTRU may select mode 1 SL to have access to dedicated resources for transmission. Conversely, if the WTRU determines the data to be less important (based on thresholds from the network and indications from the XR application in the WTRU), the WTRU may select mode 2 SL for transmission.

To enable the WTRU to assess which mode to use, the WTRU may receive different thresholds from the gNB. Thresholds may pertain to Key Performance Indicators (KPIs)/parameters, such as quality of the data, reliability to send the data, delay requirements to submit the data, etc. Each parameter may have one threshold or multiple (e.g., lower bound and upper bound) thresholds. In an example, the gNB may send one delay budget threshold to an anchor WTRU. When the anchor WTRU has data to send over the sidelink to a member WTRU, it may assess the delay requirements of the data in its buffer (that it may receive from the XR application generating the data) against the delay budget threshold provided by the gNB. If the delay requirements of the data in its buffer exceeds the delay budget threshold, the WTRU may determine that the data may not need to be sent within strict latency requirements to the member WTRU, and, as such, additional delay due to any contention resolution may be acceptable. As a result, the WTRU may select mode 2 SL transmission. In another example, the WTRU may receive a threshold from the network pertaining to QoS marking levels. The WTRU may be configured to assess the QoS of the data in its buffer against the QoS threshold from the network. If the data QoS (on a PDU basis or PDU-set basis or group of PDU sets basis or frame basis or group of frame basis) exceeds the QoS threshold from the network, the WTRU may determine that the data is important and may need to be sent via dedicated resources and, thus, select mode 1 SL transmission to send the data to a member WTRU.

The WTRU (e.g., anchor WTRU or member WTRU) may also determine the sidelink transmission mode based on the type of frame to be transmitted. In an example, the WTRU may determine that I-frames may be transmitted via mode 1 while P-frames may be transmitted via mode 2. The WTRU may choose to always send I-frames via mode 1 and P-frames via mode 2 or it may do so only in some scenarios. In an example, such a scenario may be based on the encoding scheme used. For example, if the I-frame and the P-frame are encoded in separate flows (e.g., Group of Picture (GOP)-based encoding scheme), the WTRU may always select mode 1 for I-frames transmission and mode 2 for P-frames transmission. On the other hand, if the I-frames and P-frames are encoded in the same flow (e.g., slice-based encoding scheme), the WTRU may not want to separate the I-frames from the P-frames, and, thus, may select the sidelink transmission mode based on other parameters (e.g., frame importance or per-frame delay budget as described earlier).

To enable SL transmission mode on a frame-type basis, the WTRU may need to be aware of the type of frame generated by the XR application. The WTRU may receive an indication of the frame type (e.g., in the header of the frame) and/or the encoding type which may indicate to the WTRU that all frames/PDUs/PDU-sets transmitted on a flow are of one frame type. The transmitting WTRU may send an indication in advance to the receiving WTRU of the type of transmission as well as the time and resources (e.g., carrier, BWP) on which to monitor the transmissions to avoid the receiving WTRU having to do blind decoding.

Since requesting resources on a per-TB (Transport Block) basis may introduce delay, mode 1 may include a configured-grant scheduling option to reduce delay by pre-allocating SL resources. With this scheme, the network may assign a set of SL resources to a WTRU for transmitting several TBs. The anchor WTRU may send an indication/message (e.g., via RRC signaling) to the gNB with WTRU assistance information on behalf of the member WTRU indicating information about the expected SL traffic for the member WTRU, e.g., periodicity of TBs, TB maximum size, QoS information, etc. The QoS information may include parameters/KPIs such as the latency and/or reliability required by the TBs and their priority. This information may be used by the gNB to create, configure and allocate a CG to the member WTRU that satisfies the requirements of the SL traffic. The gNB may send an indication directly to the member WTRU to indicate the parameters of the new CG (e.g., CG index, the time-frequency allocation, periodicity of the allocated SL resources, etc.) and/or it may send an indication to the anchor WTRU who may then relay that information to the member WTRU.

### Representative Procedures for Supporting Coordinated Transmissions

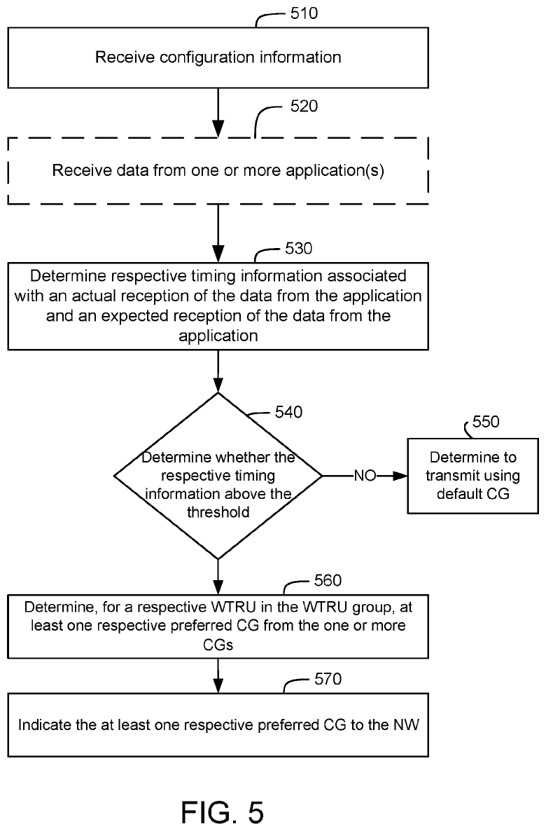

FIG. 5 is a flowchart illustrating a representative method in accordance with an embodiment. For example, FIG. 5 may illustrate a method for supporting coordinated transmissions for a group of UEs or WTRUs. In some embodiments, the method of FIG. 5 may be implemented by a WTRU, for example. According to an embodiment, the WTRU implementing the method of FIG. 5 may be a first WTRU, e.g., an anchor WTRU, of a WTRU group that includes two or more WTRUs. In other example embodiments, the method of FIG. 5 may be performed by other network nodes, entities or elements.

According to some embodiments, the method may include, at 510, receiving configuration information from a network (e.g., base station or gNB). For example, the configuration information may include or may indicate WTRU identifiers (IDs) for one or more WTRUs in the WTRU group, one or more configured grants (CGs) associated with the one or more WTRUs in the WTRU group, and a threshold value. In an embodiment, the threshold value may correspond to a jitter threshold value or a time threshold value corresponding to how much delay (e.g., maximum amount of delay) can be tolerated by the application as a result of jitter. According to a further embodiment, the threshold value may correspond to a data volume threshold value that may correspond to the volume of data (e.g., maximum volume of data) that can be tolerated in a given time period.

In an embodiment, the method may optionally include, at 520, receiving data from one or more application(s). For example, the application(s) may be, but not limited to, XR application(s), VR application(s) or AR application(s).

Based on a time that the first WTRU receives data from an application for a respective WTRU in the WTRU group, the method may include, at 530, determining respective timing information associated with an actual reception of the data from the application and an expected reception of the data from the application. For example, the timing information may include a time difference between the actual reception of the data from the application and the expected reception of the data from the application. Additionally or alternatively, where the threshold value corresponds to a data volume threshold value, the method may optionally include determining a volume of data received within a certain time period.

It is noted that, in some embodiments, “a time” as discussed herein at least in reference to FIG. 5 (e.g., in reference to a time that the first WTRU receives data) may be an indicated time that corresponds to or may be measured in, e.g., an absolute time, a relative time, a number of time slots, symbols (e.g., symbol duration), second or milliseconds, and/or the like.

According to an embodiment, the method may include, at 540, determining whether the respective timing information is above the threshold value. If it is determined at 540 that the respective timing information is not above the threshold value, then the method may include, at 550, determining to transmit data using a default CG configuration.

If it is determined at 540 that the respective timing information is above the threshold value, then, based on the determined respective timing information, the method may include, at 560, determining and/or selecting, for the respective WTRU(s) in the WTRU group, at least one respective CG from the one or more CGs. Additionally or alternatively, in an embodiment, if the volume of data received with the certain time period exceeds the threshold value, then the method may optionally include determining and/or selecting, for the respective WTRU(s) in the WTRU group, at least one respective CG from the one or more CGs (e.g., a change in resource grant configuration, such as a larger grant and/or new offset) based on the data volume threshold. For example, the determined and/or selected respective CG(s) may include or may be preferred CG(s) that would be preferred and/or requested by a respective WTRU in the group.

The method may then include, at 570, indicating the determined and/or selected at least one respective CG (e.g., preferred CG) and associated WTRU ID of the respective WTRU to the network (e.g., base station or gNB). For example, the preferred CG(s) may be CG(s) that is requested by the WTRU from the network. In one embodiment, the indicating 570 may include indicating the selected at least one respective CG (e.g., preferred CG) using any of RRC signaling, a MAC CE, or UCI.

In one embodiment, the method may optionally include receiving, from the network, a resource grant confirmation based on the determined and/or selected at least one respective CG (e.g., preferred CG) for the respective WTRU in the WTRU group.

### CONCLUSION

The publications entitled: (1) “3rd Generation Partnership Project; Technical Specification Group Services and System Aspects; Extended Reality (XR) in 5G (Release 16)” 3GPP TR 26.928, V16.1.0, December 2020; (2) 3GPP TR 28.928-Technical Specification Group Services and System Aspects; Extended Reality (XR) in 5G (Release 16) (V16.0.0); and (3) 3GPP TS 38.300-NR and NG-RAN Overall Description Stage 2 (V16.1.1) are each incorporated by reference herein in their entirety.

Systems and methods for processing data according to representative embodiments may be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention. Such software may run on a processor which is housed within a robotic assistance/apparatus (RAA) and/or another mobile device remotely. In the later a case, data may be transferred via wireline or wirelessly between the RAA or other mobile device containing the sensors and the remote device containing the processor which runs the software which performs the scale estimation and compensation as described above. According to other representative embodiments, some of the processing described above with respect to localization may be performed in the device containing the sensors/cameras, while the remainder of the processing may be performed in a second device after receipt of the partially processed data from the device containing the sensors/cameras.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods. It should be understood that the representative embodiments are not limited to the above-mentioned platforms or CPUs and that other platforms and CPUs may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mate-able and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 1¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Throughout the disclosure, one of skill understands that certain representative embodiments may be used in the alternative or in combination with other representative embodiments.

In addition, the methods described herein may be implemented in a computer program, software, or firmware incorporated in a computer readable storage medium as instructions for execution by a computer or processor to perform the actions described hereinabove. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method, implemented by a first wireless/transmit receive unit (WTRU) of a WTRU group, the method comprising:
receiving, from a network, configuration information indicating WTRU identifiers (IDs) for one or more WTRUs in the WTRU group, one or more configured grants (CGs) associated with the one or more WTRUs in the WTRU group, and a threshold value;
based on a time that the first WTRU receives data from an application for a respective WTRU in the WTRU group, determining respective timing information associated with an actual reception of the data and an expected reception of the data from the application;
determining that the respective timing information is above the threshold value;
based on the determined respective timing information, selecting, for the respective WTRU(s) in the WTRU group, at least one respective configured grant (CG) from the one or more configured grants (CGs); and
indicating the selected at least one respective configured grant (CG) and associated WTRU identifier (ID) of the respective WTRU(s) to the network.

2. The method of claim 1, wherein the indicating comprises indicating the selected at least one respective configured grant (CG) using any of radio resource control (RRC) signaling, a medium access control (MAC) control element (CE), or uplink control information (UCI).

3. The method of claim 1, further comprising receiving, from the network, a resource grant confirmation based on the selected at least one respective configured grant (CG) for the respective WTRU in the WTRU group.

4. The method of claim 1, wherein the timing information comprises a time difference between the actual reception of data and the expected reception of data from the application.

5. The method of claim 1, further comprising receiving the data from the application.

6. The method of claim 1, wherein the WTRU group comprises at least one second WTRU.

7. The method of claim 1, wherein the WTRU group comprises a collaborative WTRU group that is configured to support the application or is associated with the application.

8. The method of claim 1, wherein the threshold value comprises a value corresponding to an amount of delay that can be tolerated due to jitter.

9. The method of claim 1, wherein the application comprises an extended reality (XR) application.

10. The method of claim 1, wherein the first WTRU comprises an anchor WTRU.

11. The method of claim 1, wherein the selected at least one respective configured grant (CG) comprises a preferred configured grant (CG) that is requested from the network.

12. A first wireless/transmit receive unit (WTRU) of a WTRU group, the first WTRU comprising:
a processor and a transceiver operatively coupled to the processor;
the transceiver configured to receive, from a network, configuration information indicating WTRU identifiers (IDs) for one or more WTRUs in the WTRU group, one or more configured grants (CGs) associated with the one or more WTRUs in the WTRU group, and a threshold value;
the processor configured to:
based on a time that the first WTRU receives data from an application for a respective WTRU in the WTRU group, determine respective timing information associated with an actual reception of the data and an expected reception of the data from the application;
determine that the respective timing information is above the threshold value; and
select, for the respective WTRU(s) in the WTRU group, at least one respective configured grant (CG) from the one or more configured grants (CGs) based on the determined respective timing information; and
the transceiver configured to indicate the selected at least one respective configured grant (CG) and associated WTRU identifier (ID) of the respective WTRU(s) to the network.

13. The WTRU of claim 12, wherein the transceiver is configured to indicate the selected at least one respective configured grant (CG) using any of radio resource control (RRC) signaling, a medium access control (MAC) control element (CE), or uplink control information (UCI).

14. The WTRU of claim 12, wherein the transceiver is configured to receive, from the network, a resource grant confirmation based on the selected at least one respective configured grant (CG) for the respective WTRU in the WTRU group.

15. The WTRU of claim 12, wherein the timing information comprises a time difference between the actual reception of data and the expected reception of data from the application.

16. The WTRU of claim 12, wherein the transceiver is configured to receive the data from the application.

17. The WTRU of claim 12, wherein the WTRU group comprises a collaborative WTRU group that is configured to support the application or is associated with the application.

18. The WTRU of claim 12, wherein the threshold value comprises a value corresponding to an amount of delay that can be tolerated due to jitter.

19. The WTRU of claim 12, wherein the WTRU group comprises at least one second WTRU.

20. The WTRU of claim 12, wherein the application comprises an extended reality (XR) application.

21. The WTRU of claim 12, wherein the first WTRU comprises an anchor WTRU.

22. The WTRU of claim 12, wherein the selected at least one respective configured grant (CG) comprises a preferred configured grant (CG) that is requested from the network.

23. (canceled)
